(19) United States
(12) Patent Application Publication
(10) Pub. No.: US 2025/0174382 A1
(43) Pub. Date: May 29, 2025

(54) CROSS LAMINATION STRUCTURE AND MAGNETIC CORES COMPRISING THE SAME

(71) Applicant: City University of Hong Kong, Kowloon (HK)

(72) Inventors: Yibo WANG, Kowloon (HK); Chaoqiang JIANG, Kowloon (HK); Tianlu MA, Kowloon (HK)

(21) Appl. No.: 18/956,763

(22) Filed: Nov. 22, 2024

(30) Foreign Application Priority Data
Nov. 24, 2023 (CN) 202311583427.4

(51) Int. Cl. H01F 3/10; H01F 1/20; H01F 5/06; H02J 50/10

(52) U.S. Cl. CPC H01F 3/10; H01F 1/20; H01F 5/06; H02J 50/10

(57) ABSTRACT

A magnetic flux device configured to transmit or receive magnetic flux to or from a space beyond the magnetic flux device. The magnetic flux device includes a first electrically conductive coil and a magnetically permeable core. The magnetically permeable core includes a plurality of first laminated cores each laminated along a first direction, and a plurality of second laminated cores each laminated along a second direction substantially perpendicular to the first direction. The combination of the first and second laminations enhances the efficiency as well as thermal uniformity.

### CROSS-REFERENCE TO RELATED APPLICATIONS

The present application is based upon and claims the right of priority to CN Patent Application No. 202311583427.4, filed Nov. 24, 2023, the disclosure of which is hereby incorporated by reference herein in its entirety for all purposes.

### FIELD OF INVENTION

This invention relates to inductive power transfer (IPT) systems, and in particular to laminated cores in such systems.

### BACKGROUND OF INVENTION

IPT technology has attracted significant attention from industries and researchers.

The wireless transmission of energy offers numerous advantages for electric vehicles (EVs), enabling autonomous charging and dynamic charging with minimal effort in terms of wiring and maintenance [1], [2], [3], [4].

However, as the demand for charging power and the power density of the chargers has dramatically increased in recent years, IPT faces imminent challenges to enhance its competitiveness. One of the main obstacles is the use of soft magnetic materials (SMCs) in the technology. SMCs are essential for commercial and industrial IPT applications as they provide a low-reluctance path for magnetic flux, thereby effectively improving the power transfer efficiency by increasing the coupling coefficient and quality factors of the magnetic coupler [5]. Furthermore, the high permeability of SMCs helps in reducing the leakage stray field, which is tightly regulated by the standards. For the moment, the most commonly used SMCs for inductive power transfer are soft MnZn ferrites. The materials dominate the market due to their affordability and sufficient magnetic properties.

However, soft ferrites have certain limitations. They exhibit relatively low saturation flux density, and their properties vary significantly at different temperatures [6], [7]. Moreover, the assembly of ferrite blocks can introduce unwanted air gaps, leading to hotspots and posing a threat to the stability of the system [8], [9].

An alternative type of SMC commonly applied in transformers is the laminated core. The core materials are typically made with highly conductive and permeable materials like silicon steel and nanocrystalline alloys [10], [11], [12]. By utilizing thin laminations, the effective paths for eddy currents along the ribbon directions are reduced, thereby minimizing eddy current losses. The adoption of laminated cores offers several advantages. Firstly, these materials exhibit high saturation flux density, typically exceeding 1 T, allowing high power density. Additionally, the relative permeabilities of laminated cores are often higher than that of ferrite, with silicon steel reaching values of over 5000 and nanocrystalline materials surpassing 10000. Finally, the thermal stability of the materials outperforms MnZn ferrite [13], benefiting applications operating in different ambient temperatures. Silicon steel is laminated in layer thicknesses ranging from 100 to 300 μm and finds extensive application in low-frequency AC scenarios such as grid transformers and electrical machines. While the nanocrystalline material can be laminated as thin as 18 μm, enabling its utilization in high-frequency applications over 100 kHz.

In the field of IPT research, investigations have also been conducted on the potential utilization of laminated cores. Typically, two different lamination directions are employed: horizontally laminated cores (H-cores) and vertically laminated cores (V-cores), relative to the winding planes. In [14], [15], the authors explore the use of thin, horizontally laminated nanocrystalline ribbons to enhance the efficiency of inductive power transfer. The magnetic coupler design exhibited an approximate 2% increase in efficiency. However, the study did not address the issue of the non-uniform distribution of flux density in the horizontal lamination. Research in [16], [17], [18] involves the use of crushed nanocrystalline cores. These cores have the same material composition but undergo an additional crushing process to reduce eddy current losses. Vertical laminations become possible to implement. However, the crushing process also compromises permeability and introduces larger hysteresis losses due to the presence of distributed air gaps, thereby degrading the potential benefits of the highly permeable materials [19], [20]. Hybrid core design with vertical lamination and ferrite proposed in [21], [22], results show that the efficiency can be improved drastically by mitigating the eddy current loss of the laminated cores. The primary reason for the degraded performance of the laminated cores in IPT is the dominant leakage field, which typically accounts for a relatively small proportion compared to the total flux of the tightly coupled transformers. During the operations in IPT, the leakage flux enters the cores from different directions. The norm flux, oriented perpendicular to the sheets, induces substantial eddy current losses.

### REFERENCES

All referenced literatures throughout this disclosure are incorporated herein by reference in their entirety, which include the following references:
[1] Feng, H., Tavakoli, R., Onar, O. C., and Pantic, Z. ‘Advances in High-Power Wireless Charging Systems: Overview and Design Considerations.’ IEEE Transactions on Transportation Electrification, vol. 6, no. 3, pp. 886-919, July 2020.
[2]A. Ahmad, M. S. Alam, and R. Chabaan, ‘A Comprehensive Review of Wireless Charging Technologies for Electric Vehicles’, IEEE Transactions on Transportation Electrification, vol. 4, no. 1, pp. 38-63, March 2018.
[3]S. Jayalath and A. Khan, ‘Design, Challenges, and Trends of Inductive Power Transfer Couplers for Electric Vehicles: A Review’, IEEE Journal of Emerging and Selected Topics in Power Electronics, vol. 9, no. 5, pp. 6196-6218, October 2021.
[4] Newbolt, T., Mandal, P., Wang, H., and Zane, R. ‘Sustainability of Dynamic Wireless Power Transfer Roadway for In-motion Electric Vehicle Charging’. IEEE Transactions on Transportation Electrification, vol. 10, no. 1, pp. 11347-1362, March 2023.
[5]D. Wang et al., ‘Modern Advances in Magnetic Materials of Wireless Power Transfer Systems: A Review and New Perspectives’, Nanomaterials, vol. 12, no. 20, Art. no. 20, January 2022.
[6]P. Thakur, D. Chahar, S. Taneja, N. Bhalla, and A. Thakur, ‘A review on MnZn Ferrites: Synthesis, Characterization and Applications’, Ceramics International, vol. 46, no. 10, Part B, pp. 15740-15763, July 2020.
[7]Y. Matsuo, K. Ono, T. Hashimoto, and F. Nakao, ‘Magnetic Properties and Mechanical Strength of MnZn Ferrite’, IEEE Transactions on Magnetics, vol. 37, no. 4, pp. 2369-2372, July 2001.
[8]X. Zhang et al., ‘Ferrite Pads Gap Thermal-Magnetic Evaluation and Mitigation for 11.1 kW Wireless Power Transfer’, IEEE Transactions on Magnetics, vol. 59, no. 11, pp. 1-6, November 2023.
[9]M. Hu, U. K. Madawala, and C. Baguley, ‘The Optimal Placement of Ferrite in Inductive Power Transfer Coupling Pads’, in 2021 IEEE 12th Energy Conversion Congress & Exposition—Asia (ECCE-Asia), May 2021, pp. 469-474.
[10]X. Qi et al., ‘A Review of Fe-Based Amorphous and Nanocrystalline Alloys: Preparations, Applications, and Effects of Alloying Elements’, physica status solidi (a), vol. 220, no. 14, p. 2300079, 2023.
[11]F. C. Li et al., ‘Amorphous-nanocrystalline alloys: fabrication, properties, and applications’, Materials Today Advances, vol. 4, p. 100027, December 2019.
[12]G. Ma, L. Cheng, Y. Han, and C. He, ‘Analysis of the Magnetic Properties of Ultra-Thin Grain-Oriented Silicon Steel and Fe-Based Amorphous Alloys from Power Frequency to Intermediate Frequency’, Applied Sciences, vol. 14, no. 8, Art. no. 8, January 2024.
[13]M. Yang et al., ‘Application-Oriented Characterization and Analysis of Core Materials Under Medium-Frequency Condition’, IEEE Transactions on Power Electronics, vol. 38, no. 9, pp. 11245-11259, September 2023.
[14]D. E. Gaona, S. Ghosh, and T. Long, ‘Feasibility Study of Nanocrystalline-Ribbon Cores for Polarized Inductive Power Transfer Pads’, IEEE Transactions on Power Electronics, vol. 35, no. 7, pp. 6799-6809, July 2020.
[15]D. E. Gaona, C. Jiang, and T. Long, ‘Highly efficient 11.1-kW Wireless Power Transfer Utilizing Nanocrystalline ribbon cores’, IEEE Transactions on Power Electronics, vol. 36, no. 9, pp. 9955-9969, 2021.
[16]Y. Wang, C. Q. Jiang, C. Chen, X. Wang, X. Li, and T. Long, ‘Design and Analysis of Inductive Power Transfer System Using Nanocrystalline Flake Ribbon Core’, IEEE Journal of Emerging and Selected Topics in Power Electronics, pp. 1-1, 2024.
[17]W. Zhang, Q. Yang, Y. Li, Z. Lin, M. Yang, and M. Mi, ‘Comprehensive Analysis of Nanocrystalline Ribbon Cores in High-Power-Density Wireless Power Transfer Pads for Electric Vehicles’, IEEE Transactions on Magnetics, vol. 58, no. 2, pp. 1-5, February 2022.
[18]M. Xiong, X. Wei, Y. Huang, Z. Luo, and H. Dai, ‘Research on Novel Flexible High-Saturation Nanocrystalline Cores for Wireless Charging Systems of Electric Vehicles’, IEEE Transactions on Industrial Electronics, vol. 68, no. 9, pp. 8310-8320, September 2021.
[19]Z. Luo, X. Li, C. Jiang, Z. Li, and T. Long, ‘Permeability-Adjustable Nanocrystalline Flake Ribbon in Customized High-Frequency Magnetic Components’, IEEE Transactions on Power Electronics, pp. 1-8, 2023.
[20]Y. Wang, C. Q. Jiang, L. Mo, J. Xiang, Z. Luo, and W. Miao, ‘Magnetic Analysis of Permeability Configurable Nanocrystalline Flake Ribbons for Medium Frequency Energy Conversion Applications’, Materials Today Sustainability, vol. 27, p. 100795, September 2024.
[21]Y. Qiu, Z. Tian, X. Zhang, F. Yang, P. Chen, and H. Zhao, ‘Hybrid Core Composed of Ferrite and Nanocrystalline of High Power Wireless Charging System for Electric Vehicle Application’, in 2023 IEEE Industry Applications Society Annual Meeting (IAS), pp. 1-5, October 2023.
[22]Y. Li et al., ‘A Novel Hybrid Magnetic Core Design Method for Weight Reduction of Wireless Power Transfer Systems’, in 2024 IEEE Applied Power Electronics Conference and Exposition (APEC), February 2024, pp. 1202-1206.
[23]R. Bosshard, U. Iruretagoyena, and J. W. Kolar, ‘Comprehensive Evaluation of Rectangular and Double-D Coil Geometry for 50 kW/85 kHz IPT System’, IEEE Journal of Emerging and Selected Topics in Power Electronics, vol. 4, no. 4, pp. 1406-1415, December 2016.
[24]T. Lammle, N. Parspour, and J. Holz, ‘Comparison of Circular and Double-D Coil Topologies for Automotive Inductive Charging Systems’, in 2020 IEEE PELS Workshop on Emerging Technologies: Wireless Power Transfer (WoW), November 2020, pp. 68-73.
[25]J. Wang, H. Lin, Y. Huang, and X. Sun, ‘A New Formulation of Anisotropic Equivalent Conductivity in Laminations’, IEEE Transactions on Magnetics, vol. 47, no. 5, pp. 1378-1381, May 2011.
[26]G. Bertotti, F. Fiorillo, and P. Mazzetti, ‘Basic Principles of Magnetization Processes and Origin of Losses in Soft Magnetic Materials’, Journal of Magnetism and Magnetic Materials, vol. 112, no. 1, pp. 146-149, July 1992.
[27]Z. Zhang, J. I. Ceballos, A. Nysveen, and T. S. Haugan, ‘Computation of Core Losses in Electrical Steel Laminations With Impacts of Normal Flux and PWM Switching Considered’, IEEE Transactions on Magnetics, vol. 60, no. 3, pp. 1-4, March 2024.
[28]W. Wang, A. Nysveen, and N. Magnusson, ‘Eddy Current Loss in Grain-Oriented Steel Laminations Due to Normal Leakage Flux’, IEEE Transactions on Magnetics, vol. 57, no. 6, pp. 1-4, June 2021.
[29]Z. Ren, “T-Q Formulation for Eddy-current Problems in Multiply Connected Regions,” IEEE Transactions on Magnetics, vol. 38, no. 2, pp. 557-560, March 2002.
[30]P. Beckley and G. K. Sujan, ‘Steels, Silicon Iron-Based: Magnetic Properties’, in Reference Module in Materials Science and Materials Engineering, Elsevier, 2016.

### SUMMARY OF INVENTION

In one aspect of the invention, there is provided a magnetic flux device configured to transmit or receive magnetic flux to or from a space beyond the magnetic flux device. The magnetic flux device includes a first electrically conductive coil and a magnetically permeable core. The magnetically permeable core includes a plurality of first laminated cores each laminated along a first direction, and a plurality of second laminated cores each laminated along a second direction substantially perpendicular to the first direction.

In some embodiments, the magnetic flux device further includes a second electrically conductive coil which is configured side-by-side with the first electrically conductive coil to form a double-D winding structure.

In some embodiments, both the first direction and the second direction are parallel to a virtual plane in which the first electrically conductive coil is located.

In some embodiments, the second direction is parallel to a virtual line that connects a centre of the first electrically conductive coil and a centre of the second electrically conductive coil. The second direction and the first direction are parallel to a virtual plane in which the first electrically conductive coil and the second electrically conductive coil are located.

In some embodiments, each first laminated core includes a plurality of first laminations, and each second laminated core includes a plurality of second laminations.

The first laminations and the second laminations are co-planar.

In some embodiments, the plurality of the first laminated cores is placed on one side of the plurality of the second laminated cores, as a magnetic flux balancer, to reduce flux concentration.

In some embodiments, the plurality of the first laminations includes a plurality of insulation layers and a plurality of first soft magnetic core (SMC) layers that are interlaced.

In some embodiments, both the plurality of insulation layers and the plurality of first SMC layers extend along the first direction.

In some embodiments, the plurality of the second laminations contains a plurality of insulation layers and a plurality of second SMC layers that are interlaced.

In some embodiments, both the plurality of insulation layers and the plurality of second SMC layers extend along the second direction.

In some embodiments, the plurality of first SMC layers has higher permeability in directions along a layer surface than the plurality of the second SMC layers.

In some embodiments, the plurality of first SMC layers has lower permeability in a direction perpendicular to a layer surface than the plurality of the second SMC layers.

In some embodiments, the plurality of first SMC layers has higher conductivity than the plurality of the second SMC layers.

In some embodiments, the plurality of first SMC layers is made of a Fe-based nanocrystalline material. The plurality of second SMC layers is made of a nanocrystalline flake ribbons (NFR) material.

In some embodiments, the magnetic flux device further includes a base plate on which a plurality of core clamps is configured. The core clamps secure the plurality of first laminations and/or the plurality of second laminations to the base plate.

In some embodiments, the magnetic flux device further includes an insulation film arranged between the first electrically conductive coil and the magnetically permeable core.

Exemplary embodiments of the invention therefore provide a cross-lamination structure that combines the advantages of both vertical and parallel laminations, effectively mitigating thermal imbalances and enhancing the efficiency. The cross-lamination contains at least two variations. The cross-laminated cores significantly reduce eddy currents, which are loops of electrical currents induced within conductors by changing magnetic fields, which if unchecked, can cause substantial power losses and generate excessive heat. By minimizing these currents, the cores ensure more efficient transfer of magnetic flux, which is critical for the energy transfer in wireless charging as an example of the applications of the invention. Secondly, the cross-laminated cores help maintain high magnetic permeability. This property is crucial for achieving strong magnetic coupling between the transmitter and receiver coils—the primary pathway through which energy is transferred wirelessly. High permeability allows for the generation of a strong magnetic field with less energy, thereby boosting the system's overall efficiency. Furthermore, the cross-lamination helps to balance the flux density distributions within the core. Laminated cores typically exhibit high anisotropy, resulting in an uneven flux density distribution. However, by combining vertical and horizontal laminations, the anisotropic permeability can be effectively balanced, leading to a more uniform flux density distribution. This, in turn, reduces core loss by eliminating flux concentration, ultimately resulting in improved efficiency. Moreover, the cross-laminated cores help increase the power density. Due to the fact that most of the lamination materials exhibit high saturation flux density, the cores can be designed very thin, reducing the overall dimension of the wireless charging device, for example a wireless charging pad.

### BRIEF DESCRIPTION OF FIGURES

The foregoing and further features of the present invention will be apparent from the following description of embodiments which are provided by way of example only in connection with the accompanying figures, of which:

FIG. 1a shows the exploded view of a wireless charging pad for EVs according to a first embodiment of the invention.

FIG. 1b is a side view of the charging pad of FIG. 1a by looking into the y direction.

FIG. 2a shows enlarged view of the cross-lamination structure of the magnetically permeable core in the wireless charging pad of FIGS. 1a-1b.

FIG. 2b shows a cross-lamination structure of the magnetically permeable core according to another embodiment of the invention, in which a V-core is configured on the same side of multiple H-cores.

FIG. 2c shows a cross-lamination structure of the magnetically permeable core according to another embodiment of the invention, in which two V-cores are configured on two opposite sides of a H-core.

FIG. 2d shows a cross-lamination structure of the magnetically permeable core according to another embodiment of the invention, in which two V-cores are configured on two opposite sides of multiple H-cores.

FIG. 2e shows a cross-lamination structure of the magnetically permeable core according to another embodiment of the invention, in which multiple sets of V-cores are separated from each other by H-cores.

FIG. 3a illustrate the structure of a V-core in the magnetically permeable cores of FIGS. 2a-2b.

FIG. 3b illustrate the structure of a H-core in the magnetically permeable cores of FIGS. 2a-2b.

FIG. 4 illustrate anisotropic permeability and conductivity of horizontally and vertically laminated cores.

FIG. 5 is a table showing several commercial core materials with MnZn ferrite.

FIG. 6a shows an original track core of horizontally laminated nanocrystalline cores under tests.

FIG. 6b shows cut cores from the original track core in FIG. 6a.

FIG. 6c shows prepared I-type cores from the cut cores in FIG. 6b, for IPT.

FIG. 7 illustrates a toroidal core with vertically laminated nanocrystalline flake ribbons.

FIG. 8 illustrates a measurement setup for toroidal and race track cores as in FIG. 7 and FIG. 6a respectively.

FIG. 9 shows measurement results of core losses for Finemet®, NFR1, NFR2, and NFR3 materials in 50 kHz, 85 kHz, 100 kHz, and 150 kHz, respectively.

FIG. 10 illustrates a 3-D finite element simulation model of IPT with double-D windings.

FIG. 11 illustrates the imbalance flux distribution of H-cores, revealing high edge losses due to the lamination structure.

FIG. 12 illustrates the imbalance flux distribution of V-cores, caused by the high eddy currents.

FIG. 13a illustrates the first variation of cross-lamination structure (as shown in FIG. 2a) with Finemet® & NFR1, and the flux density distribution with horizontal and vertical laminations placed alternatively.

FIG. 13b illustrates the first variation of cross-lamination structure with Finemet® & NFR2, and the flux density distribution with horizontal and vertical laminations placed alternatively.

FIG. 13c illustrates the first variation of cross-lamination structure with Finemet® & NFR3, and the flux density distribution with horizontal and vertical laminations placed alternatively.

FIG. 13d illustrates the second variation of cross-lamination structure (as shown in FIG. 2b) with Finemet® as H-cores only, and the flux density distribution of the magnetic core area.

FIG. 13e illustrates the second variation of cross-lamination structure with Finemet® & NFR3, and the flux density distribution of the magnetic core area.

FIG. 14 illustrates core loss comparison with horizontal, vertical, and cross laminations.

FIG. 15 shows an experiment setup and measurement devices for the magnetic evaluator.

FIG. 16 shows a detailed structure and the placement of thermal sensors for horizontal and cross laminations.

FIG. 17a illustrates temperatures of the measured positions for H-cores under 23° C. ambient temperature and natural convection with 12 A output current, triggering over-temperature protection.

FIG. 17b illustrates temperatures of the measured positions for H-cores under 23° C. ambient temperature and natural convection with 15 A output current, triggering over-temperature protection.

FIG. 18a shows comparison between thermal image and simulated flux density distribution in the experimental verification with 10 A output current for H-cores.

FIG. 18b shows comparison between recorded temperature and simulated flux density in the center area in the experimental verification with 10 A output current for H-cores.

FIG. 19a shows temperature rise test results with Finemet® & NFR1 configurations under 5 A output current.

FIG. 19b shows temperature rise test results with Finemet® & NFR1 configurations under 10 A output current.

FIG. 19c shows temperature rise test results with Finemet® & NFR1 configurations under 15 A output current.

FIG. 19d shows temperature rise test results with Finemet® & NFR2 configurations under 5 A output current.

FIG. 19e shows temperature rise test results with Finemet® & NFR2 configurations under 10 A output current.

FIG. 19f shows temperature rise test results with Finemet® & NFR2 configurations under 15 A output current.

FIG. 19g shows temperature rise test results with Finemet® & NFR3 configurations under 5 A output current.

FIG. 19h shows temperature rise test results with Finemet® & NFR3 configurations under 10 A output current.

FIG. 19i shows temperature rise test results with Finemet® & NFR3 configurations under 15 A output current.

FIG. 20 shows comparison of the final recorded temperatures and the DC-DC efficiency at 10.8 kW output power.

### DETAILED DESCRIPTION OF PREFERRED EMBODIMENTS

In the claims which follow and in the preceding description, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

As used herein and in the claims, “couple” or “connect” refers to electrical coupling or connection either directly or indirectly via one or more electrical means unless otherwise stated.

Terms such as “top”, “bottom”, “horizontal”, “vertical”, “upwards”, “downwards”, “above”, “below” and similar terms as used herein are for the purpose of describing the invention in its normal in-use orientation. However, they should not be interpreted as imposing any strict limitation to the claims regarding orientation or relation positions of the relevant components.

Embodiments of the invention are related to the field of IPT systems, specifically focusing on the implementation of laminated cores to enhance system performance. In some embodiments, lamination structures including vertical and parallel configurations, employing Fe-based nanocrystalline materials and NFR respectively, are chosen for their superior core loss characteristics. In the detailed exposition, the disclosure introduces material modeling and loss analysis methodologies that integrate toroidal measurements with assessments of eddy current losses induced by norm flux. Utilizing the Finite Element Method (FEM) under this modeling framework, it has been determined that both lamination structures exhibit notable flux density and thermal imbalances, which present significant operational challenges for IPT systems.

In response to these findings, the cross-lamination structure is proposed which combines the advantages of both vertical and parallel laminations, effectively mitigating the aforementioned thermal imbalances. Experimental simulations, as delineated herein, demonstrate an enhancement in system performance, which is further corroborated by empirical testing. The results of implementing the integrated lamination approach are profound, extending the operational duration of IPT systems, reducing the maximum operational temperature by approximately 40° C., and achieving an efficiency increase of over 0.4% at a power output of 10.8 kW. The core design not only offers a practical solution for the deployment of laminated cores in IPT applications but also significantly augments their efficiency and thermal management capabilities.

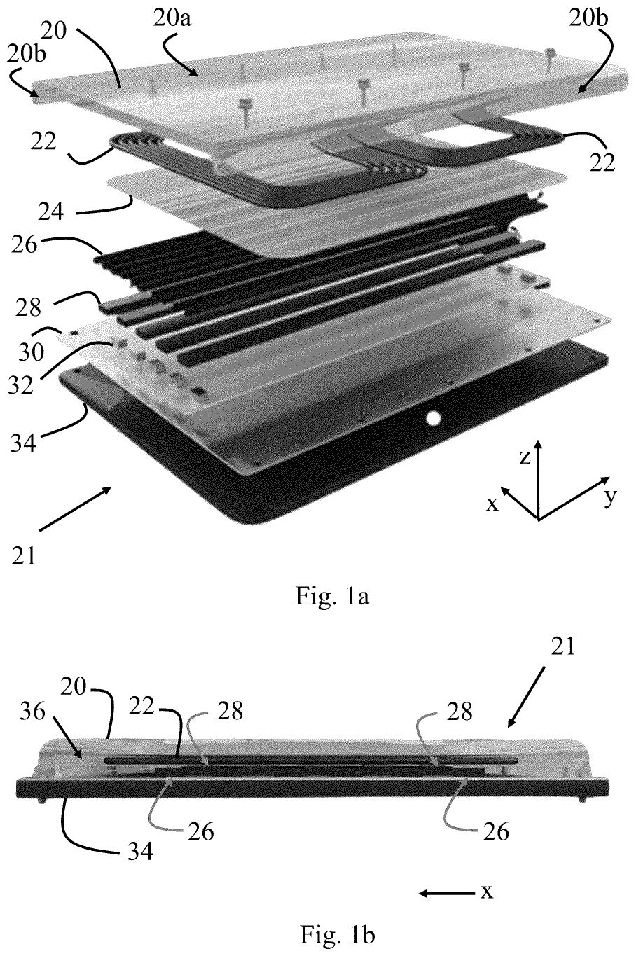

FIGS. 1a and 1b show a first embodiment of the invention, which is a wireless charging pad 21 for charging EVs. The wireless charging pad 21 has a substantially planar shape and can be installed on the ground, which allows an EV (not shown in FIGS. 1a-1b) to approach and be positioned over the wireless charging pad 21. As skilled persons will understand, on EVs that support wireless charging, there is installed a receiver coil (not shown) fitted to an underside of the EV, for example at a location between front wheels of the EV. Once the EV parks directly over the wireless charging pad 21, and the receiver coil is properly aligned with the wireless charging pad 21, there will be energy transfer as electricity flows from the wireless charging pad 21 to the vehicle through a magnetic field, charging the EV's battery.

FIG. 1a best illustrates the internal structure of the wireless charging pad 21. On a first side of the wireless charging pad 21 there is configured a top plate 20 which includes not only a planar part 20a and also side walls 20b extending from the planar part 20a. The side walls 20b together with the planar part 20a and a back plate 34 of the wireless charging pad 21 define a sealed internal space 36 for accommodating essential components of the wireless charging pad 21, which will be described later. The top plate 20 may be made from a transparent material which at the same time is strong enough to provide protections to the essential components in the internal space 36, for example from running over of vehicles.

Right underneath the top plate 20 is the coil structure of the wireless charging pad 21, which includes two identical electrically conductive coils 22. Each coil 22 has a substantially stadium shape. The two coils 22 are arranged side-by-side, and they are located in a same virtual plane (not shown, which is the winding plane) that is parallel to the planar part 20a of the top plate 20. For the purpose of easy reference, define the direction along which a virtual line (not shown) connecting centers (not shown) of the two coils 22 to be the y direction. In other words, the two coils 22 are positioned one after another along the y direction. However, for each coil 22 its dimension along a x direction is larger than that along the y direction, because of the stadium shape. The x direction is perpendicular to the y direction, whereas a z direction is defined as the stacking direction of the top plate 20, the coils 22, the bottom plate 34, etc. The three directions x, y and z are shown in FIG. 1a. The two coils 22 form a double-D winding structure, since the stadium shape of each coil 22 is also similar to a ‘D” shape. Each coil 22 therefore extend substantially in the x and y directions.

At the center of the wireless charging pad 21 there is a magnetically permeable core which includes a plurality of V-cores 26 and a plurality of H-cores 28. The V-core 26 is named since laminations in the V-core 26 contain layers that extend along a vertical direction that is defined to be the y direction. The H-core 28 is named since laminations in the H-core 28 contain layers that extend along a horizontal direction, which is defined to be the x direction. The laminations in the V-cores 26 and the H-cores 28 will be described in more detail later. Note that although in the exploded view of FIG. 1a, the V-cores 26 and the H-cores 28 appear to be offset from each other on the z direction, all the lamination cores actually are co-planar and located in a same virtual plane (not shown) that extends in the x and y directions.

Between the magnetically permeable core and the two coils 22, there is an insulation film 24 placed, which insulates the magnetically permeable core from the coils 22. Next, underneath the magnetically permeable core there is an aluminum plate 30, on which there are multiple core clamps 32 configured. The core clamps 32 are used to fix laminations 26a, 28a in the magnetically permeable core on the aluminum plate 30. As shown in FIG. 1a, the core clamps 32 are located near two ends of the aluminum plate 30, and are separated in the y direction at a distance slightly longer than lengths of laminations 26a, 28a. Lastly, underneath the aluminum plate 30 there is the back plate 34.

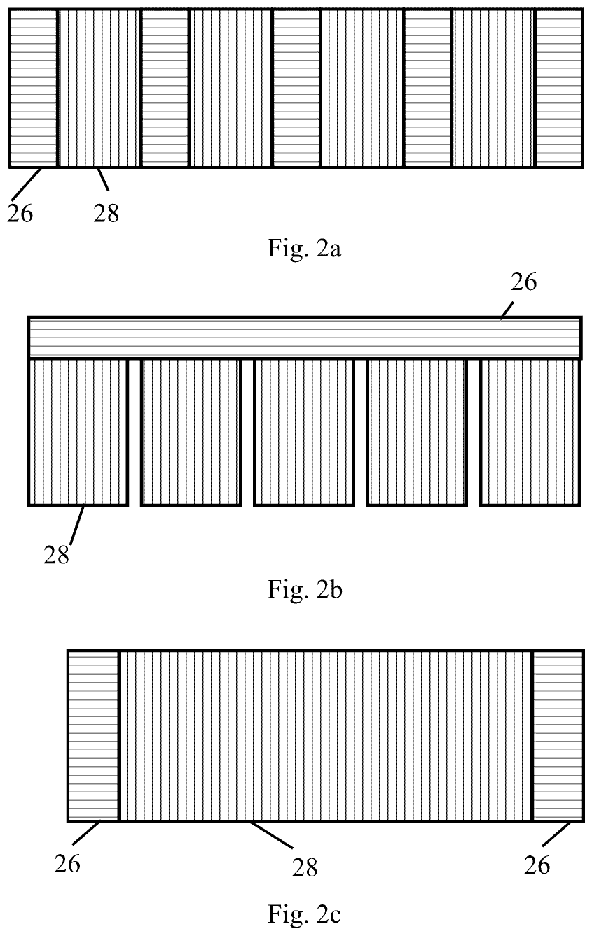

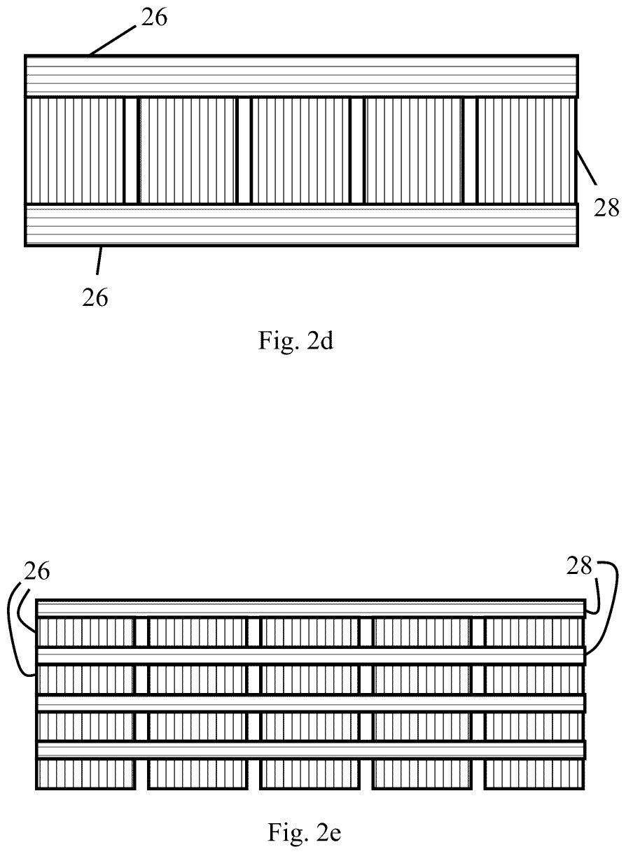

Turning to FIGS. 2a-2e, which show several exemplary variations of the magnetically permeable core, but with only a portion of the magnetically permeable core in each of the figures for the sake of clarity. For the first variation as shown in FIG. 2a, it is actually the structure of the magnetically permeable core as shown in FIGS. 1a-1b, and one can see that each one of the H-cores 28 and V-cores 26 contains multiple layers, but the layers in the H-cores 28 are perpendicular to those in the V-cores 26. The H-cores 28 and the V-cores 26 are interlaced, which means the H-cores 28 and V-cores 26 are alternatively arranged, and no two H-cores 28 are placed adjacent each other, so are the V-cores 26. For each V-core 26 there are two H-core 28 located immediately adjacent to the two sides of the V-core 26. As shown in FIGS. 1a-1b, the number of H-cores 28 is larger than the number of V-cores 26. In other words, at the two sides of the magnetically permeable core along the x direction, there are two H-cores 28 respectively as the outermost lamination cores. For each of these two outermost lamination cores one of its two sides is left empty, while at the other side, a V-core 26 is configured.

For the second variation as shown in FIG. 2b, a V-core 26 is placed on a same side (the top side in FIG. 2b) of a plurality of H-cores 28, acting like a bridge connecting all the magnetic layers of the H-cores 28. For the third variation as shown in FIG. 2c, two V-cores 26 are placed on two opposite sides (the left and right sides in FIG. 2c) of a single H-core 28. The H-core 28 in FIG. 2c spans a great width as compared to the width of each of the V-cores. For the fourth variation as shown in FIG. 2d, it is similar to the structure in FIG. 2b, but compared to FIG. 2b there is another V-core 26 placed on a second side (the bottom side in FIG. 2d) of a plurality of H-cores 28. For the fifth variation as shown in FIG. 2e, there are multiple sets of V-cores 26, with each set of V-cores 26 aligned in a row (there are four such rows as shown in FIG. 2e). Between every two adjacent sets of the V-cores 26, there is an elongated H-core 28 that has a length equal to the total length of five V-cores 26 in a set. It should be noted that each of the lamination structures as shown in FIGS. 2b-2e may be used in the wireless charging pad in FIGS. 1a-1b by replacing the structure of FIG. 2a.

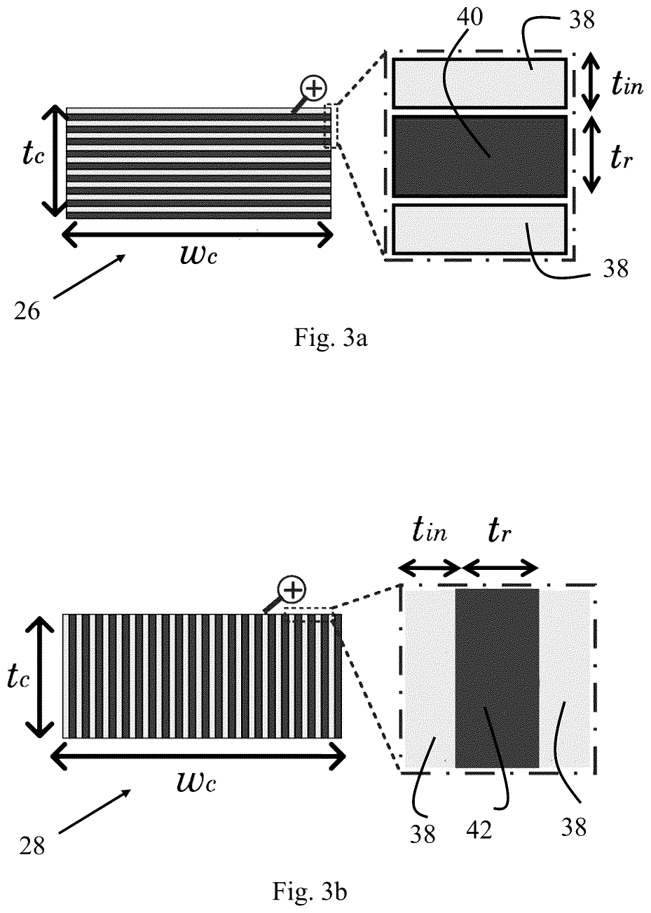

As mentioned above, for a H-core 28 the laminations contain layers that extend along the horizontal direction, which is defined to be the x direction in FIG. 1a. FIG. 3a shows the composition of a H-core 28 which include a plurality of SMC layers 40 and a plurality of insulation layers 38. The SMC layers 40 and the insulation layers 38 are interlaced, which means the SMC layers 40 and the insulation layers 38 are alternatively arranged, and no two SMC layers 40 are placed adjacent each other, so are the insulation layers 38. It should be noted that although in FIGS. 2a, 2b and 3a the SMC layers 40 and the insulation layers 38 are shown as two-dimensional components and only extend in a single (horizontal direction), in fact each of these layers has an area so not only do they extend in the horizontal direction, but they also extend in another direction which is the z direction in FIG. 1a.

Similarly, for the V-core 26 the laminations contain layers that extend along the vertical direction, which is defined to be the y direction in FIG. 1a. FIG. 3b shows the composition of a V-core 26, which include a plurality of SMC layers 42 and a plurality of insulation layers 38. The SMC layers 42 and the insulation layers 38 are interlaced, which means the SMC layers 42 and the insulation layers 38 are alternatively arranged, and no two SMC layers 42 are placed adjacent each other, so are the insulation layers 38. It should be noted that although in FIGS. 2a, 2b and 3b the SMC layers 42 and the insulation layers 38 are shown as two-dimensional components and only extend in a single (vertical direction), in fact each of these layers has an area so not only do they extend in the horizontal direction, but they also extend in another direction which is the z direction in FIG. 1a.

The SMC layers 42 in the V-cores 26 and the SMC layers 40 in the H-cores 28 can be made of the same materials or different materials. In a preferred embodiment, the H-cores 28 should use materials with medium permeability between 3000-8000 to ensure effectiveness, and the V-cores 26 should use materials with high saturation flux density over 1 T and high permeability over 10000, such as silicon steel and nanocrystalline alloy. In one exemplary embodiment, the core material for vertical lamination has a permeability of 17710. Preferably, as will be described in more details below, in one preferred implementation the Finemet® nanocrystalline alloy (which can be obtained from Proterial, Ltd.) is configured with horizontal laminations, while NFR is configured as vertical laminations.

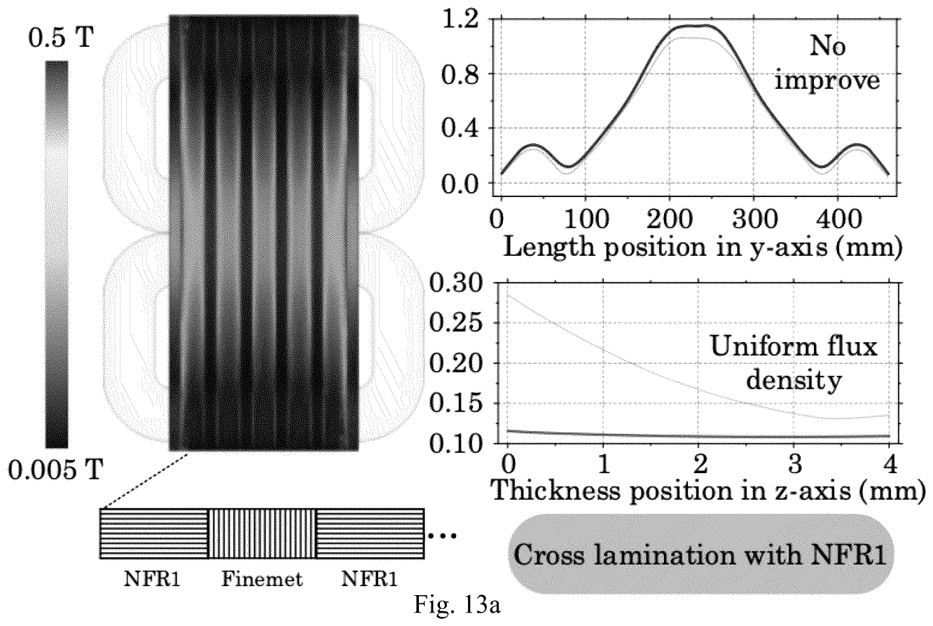

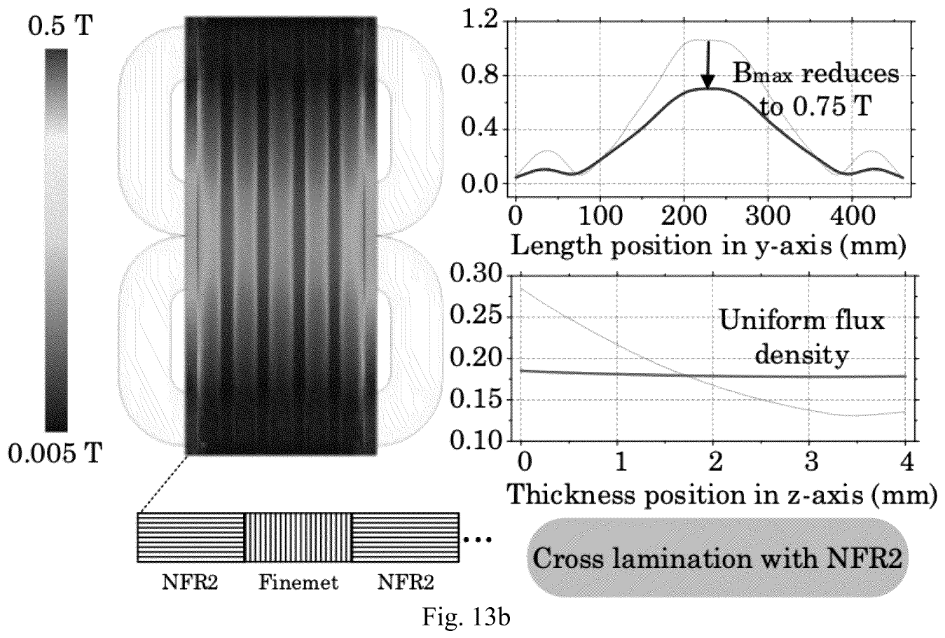

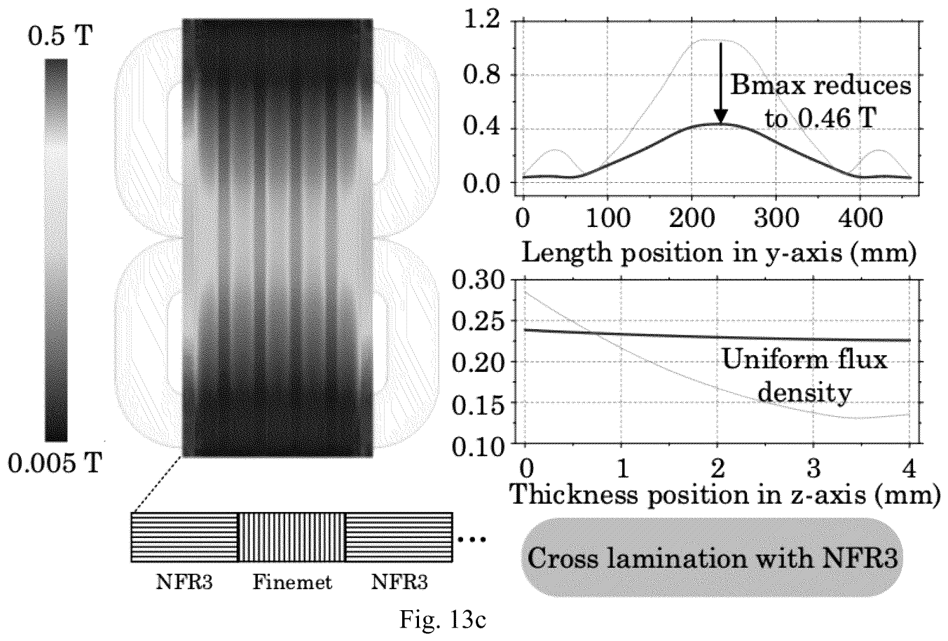

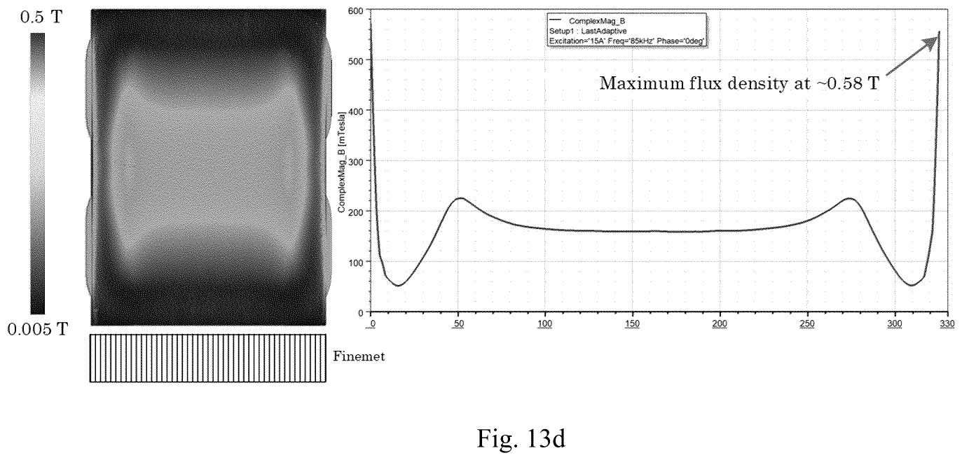

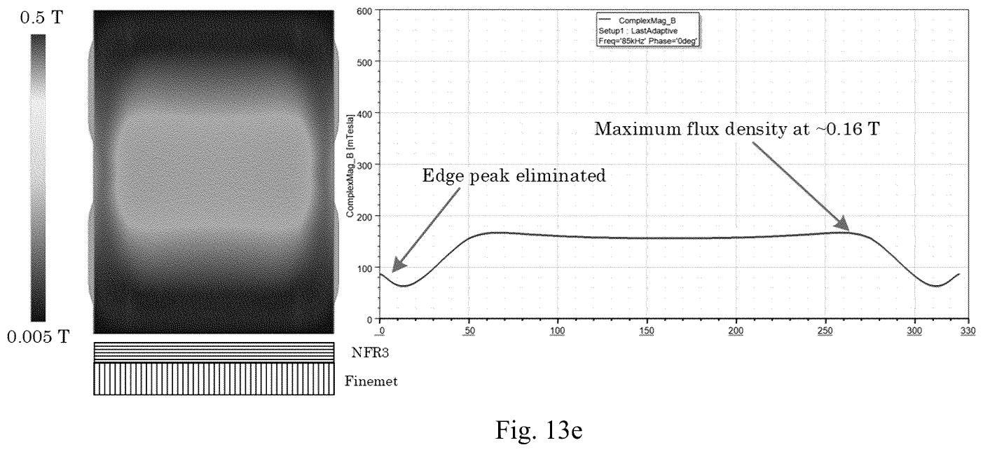

The width of the vertical lamination shall be in the range of 20-30 mm, while the parallel laminations shall remain below 15 mm. In this case, the main flux is conducted primarily with the vertical laminations, due to their high permeability and low core loss. The parallel laminations behave as shielding to reduce the edge loss of the vertical laminations. Meanwhile, as the permeability of parallel laminations increases, the flux density distribution becomes more uniform, as shown in FIGS. 13a-13e.

Having described the structure of the wireless charging pad 21, the descriptions will now come to the working principle of the wireless charging pad 21. In particular, in the following sections the flux density distribution and core loss behavior of the laminated cores in the IPT (i.e., the wireless charging pad 21) are first analyzed. Due to the dominating leakage flux, the mathematical model of the equivalent magnetic circuit in IPT cannot be precisely described. Therefore, finite element simulation is used as the tool for macroscopic analysis. Experiments are performed to compare and verify the performances.

As mentioned above, in the wireless charging pad 21 a double-D winding structure is utilized, due to its superior performance in minimizing leakage fields when compared to rectangular and circular windings [23], [24]. Moreover, the use of this structure complies with the SAE standards (from SAE International) for EVs. As shown in FIGS. 3a and 3b, for each lamination core (i.e., a H-core 28 or a V-core 26), it has an overall thickness denoted as t_{c} and an overall width of w. For each SMC layer 40 in the H-cores 28, as well as each SMC layer 42 in the V-cores 26, it has a thickness of tᵣ, while the insulation layers 38 that separate the SMC layers 40, 42 each has a thickness of tᵢₙ. Hence, the stacking factor Fₛ can be defined using equation (1).

$${F}_{s} = \frac{{t}_{r}}{{t}_{in} + {t}_{r}} \qquad ( 1 )$$

A stacking factor of Fₛ=1 leads to a solid core composition. A higher stacking factor is preferred, given that the material of the insulation layers 38 offers sufficient insulation to reduce eddy currents. A thinner SMC layer 40, 42 would lead to lower eddy current loss. Nonetheless, this imposes limitations on the stacking factor as the insulation layer 38 must maintain a thickness that ensures adequate insulation.

The orientation of the lamination can be determined relative to the winding plane (e.g. the plane in which the coils 22 are wound). In V-core configurations, the lamination direction aligns parallel to the winding plane, whereas in H-core configurations, it aligns perpendicular to the winding plane. Intuitively, vertical lamination leads to higher core loss because the normal flux from the windings enters a larger surface area of the sheets, resulting in a larger eddy current path and increased Joule losses. On the other hand, H-cores 28 result in a significant increase in the length-width ratio of the core, which raises manufacturing costs and lowers the yield rate [15].

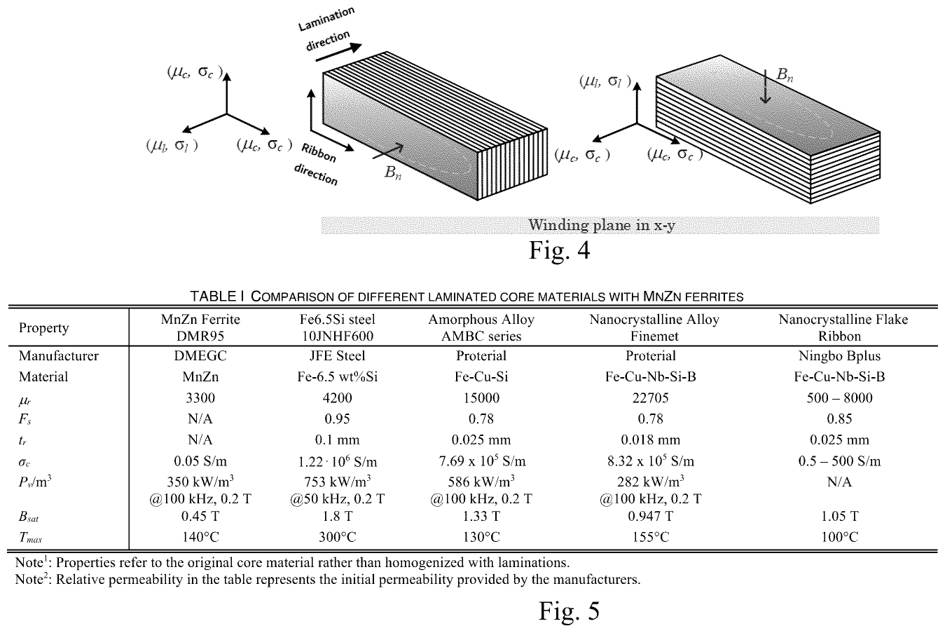

For laminated cores in transformers and inductors, the magnetic path forms a closed loop filled with material that has a much higher permeability than air. As a result, the leakage flux can be ignored other than in the area of the cut gaps. The material in the unidirectional path can be assumed to be isotropic. Nevertheless, in an IPT operating situation, leakage flux dominates. Therefore, the anisotropic characteristic of the material must be considered. The homogenization method is typically used to evaluate anisotropic behavior [25]. With the assumption that the adhesive layer is non-conductive and has relative air permeability μ₀, the permeability and conductivity along the ribbon and lamination directions can be expressed as in (2).

$$\{ \begin{matrix}{μ}_{1} & = \frac{{μ}_{r} {μ}_{0}}{( 1 - {F}_{s} ) {μ}_{r} + {F}_{s} {μ}_{0}} \\ {μ}_{c} & = ( 1 - {F}_{s} ) {μ}_{0} + {F}_{s} \cdot {μ}_{r} \\ {σ}_{l} & \approx \frac{1}{F} ( \frac{{t}_{c}}{{w}_{c}} ) {σ}_{r} \\ {σ}_{c} & = {F}_{s} {σ}_{r}\end{matrix} \qquad ( 2 )$$

where □ₗ and □_{c} are the permeabilities in the lamination and ribbon directions (the definitions of which are shown in FIG. 4) respectively. The respective conductivities are denoted as σₗ and σ_{c}. The □ᵣ represents the relative permeability.

Since both horizontal and vertical laminated cores are uniaxially anisotropic, the homogenized permeability and conductivity can be modeled as rank-2 diagonal tensors in (3).

$$( {μ}_{eq} , {σ}_{eq} ) = [ \begin{matrix}( {μ}_{xx} , {σ}_{rr} ) & 0 & 0 \\ 0 & ( {μ}_{yy} , {σ}_{yy} ) & 0 \\ 0 & 0 & ( {μ}_{zz} , {σ}_{zz} )\end{matrix} ] \qquad ( 3 )$$

The horizontal and vertical lamination exhibit different tensors. FIG. 4 illustrates the configuration for the respective configurations. The windings are assumed to be placed in the x-y plane.

Based on the permeability and conductivity tensor setup, the distribution of flux density and core loss can be simulated with FEM. In this case, both losses occurred in ribbon and lamination directions are included.

The famous Bertotti model proposed in [26] separates the core loss Pᵥ into hysteresis loss Pₕ, eddy current loss Pₑ, and excess loss P_{c} based on their mathematical characteristics in response to the flux density Bₘ and frequency f_{sw}.

$$\begin{matrix}{P}_{v} & = {P}_{h} + {P}_{e} + {P}_{c} \\ & = {k}_{h} {f}_{sw} {B}_{m}^{a} + {k}_{e} {( {f}_{sw} {B}_{m} )}^{2} + {k}_{c} {( {f}_{sw} {B}_{m} )}^{1.5}\end{matrix} \qquad ( 4 )$$

where kₕ, kₑ, and k_{c} are the coefficients for the hysteresis loss Pₕ, eddy current loss Pₑ, and excess loss P_{c} respectively. In particular, the eddy current loss coefficient kₑ is determined by (5).

$${k}_{e} = \frac{{π}^{2} \cdot {σ}_{c} \cdot {t}_{r}^{2}}{6} \qquad ( 5 )$$

However, Eqn. (5) assumes that the majority of the flux remains along the sheet direction, and the induced eddy currents on the sheet surface can be neglected. This is true in transformer and inductor design where only a small controlled air gap is present. Nevertheless, in IPT applications, the eddy current loss caused by the normal flux is present for both vertical and horizontal laminations, as illustrated in FIG. 4. Research in [27], [28] highlights that this type of eddy current loss, originating from the normal flux Bₙ, can be independently calculated and modeled from the hysteresis loss of the soft magnetic material. Furthermore, the hysteresis loss brought by the normal flux can be neglected. The eddy current loss Pₙ in a conductive surface is defined as (6).

$${P}_{n} = \int \frac{1}{{σ}_{c}} {J}_{n} \cdot {J}_{n}^{*} dV \qquad ( 6 )$$

where Jₙ is the eddy current density, induced by the norm flux. The norm flux Bₙ is the subcomponent of the flux density vector at the specific position that is perpendicular to the SMC surface. Jₙ can be further represented by the Maxwell equations and Ohm's Law in (7).

$$\{ \begin{matrix}∇ \times {E}_{n} & = - j ω {B}_{n} \\ {J}_{n} & = {σ}_{c} {E}_{n}\end{matrix} \qquad ( 7 )$$

The equations can be numerically solved with the FEM using T−Ω formulation to separate the regions and taking boundary conditions into consideration [29].

The total of laminated cores in IPT can be eventually obtained as (8).

$${P}_{total} = {P}_{v} + {P}_{n} \qquad ( 8 )$$

The first term, Pᵥ, represents the core loss when the flux direction is aligned with the sheet direction. It is determined experimentally, as physically separating different types of core loss during measurement is not practical. The second term, Pₙ, cannot be directly measured; however, it can be estimated using FEM simulations by calculating Bₙ and Jₙ. Therefore, in this disclosure, the two methods are combined for the laminated core loss analysis.

Since Pₙ only accounts for the eddy current loss caused by the norm flux, and the eddy current loss due to the parallel flux is already included in Pᵥ. Therefore, σₗ can be set to 0 to avoid duplicate calculations of the eddy current loss.

Several types of core materials are available in the market and can be used for laminated cores for IPT applications. Table I in FIG. 5 shows the comparison of these core materials with MnZn ferrite. Note that the data is acquired from manufacturers' datasheets and product catalogs, and may be subject to deviation from the real measurements. The permeability of the laminated cores demonstrates higher values than the MnZn ferrites, with the amorphous and nanocrystalline alloy reaching over 10000. The silicon steel is typically laminated with 0.1 mm sheet thickness, which makes the stacking factor up to 0.95, higher than the amorphous and nanocrystalline alloy of 0.84 and 0.77, respectively. According to the study in [12], [30], the major contributor to the core loss of silicon steel above 400 Hz is the eddy current loss. Therefore, the high sheet thickness leads to the highest core loss at a high frequency of over 50 kHz. The amorphous alloy elevated the permeability to 15000 and reduced the core loss to be able to operate at around 100 kHz, thanks to the thin lamination of 25 μm. The Fe-based nanocrystalline alloy further reduced the ribbon thickness to 18 μm. In the additional annealing process during which a design direction magnetic field is applied, the B-H curve of the material can achieve low squareness and lead to a low hysteresis loss. The core loss behavior can outperform the MnZn ferrite in the frequency below 100 kHz.

NFR are created by further crushing Fe-based nanocrystalline ribbons, resulting in decreased conductivity and permeability. This lower conductivity allows for the use of NFR in vertical lamination configurations, as Pₙ is inversely proportional to the conductivity. Therefore, as mentioned above for the magnetically permeable core the Finemet® nanocrystalline alloy is configured with horizontal laminations, while NFR is configured as vertical laminations. Optimization details will be provided below.

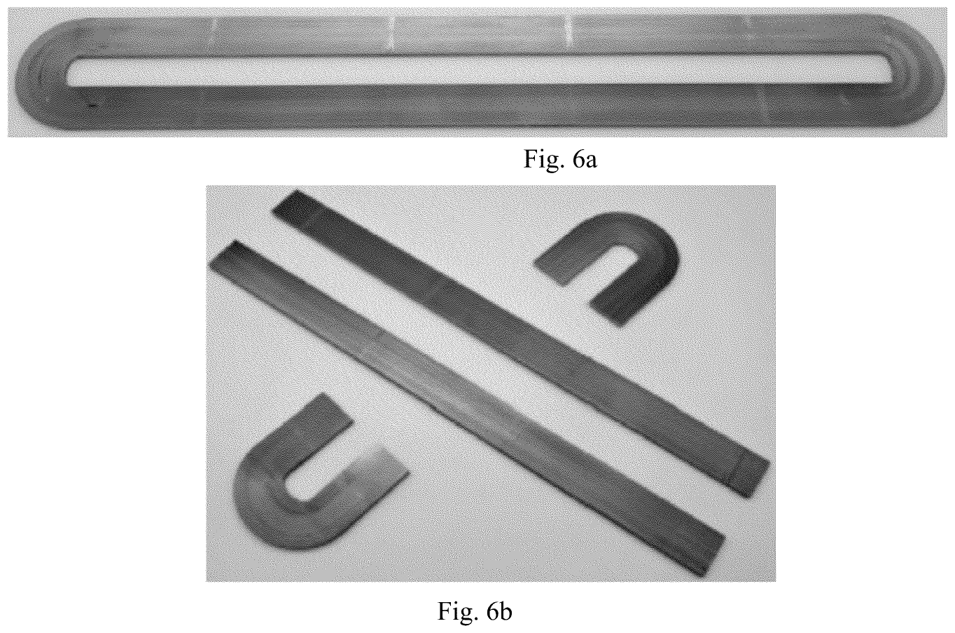

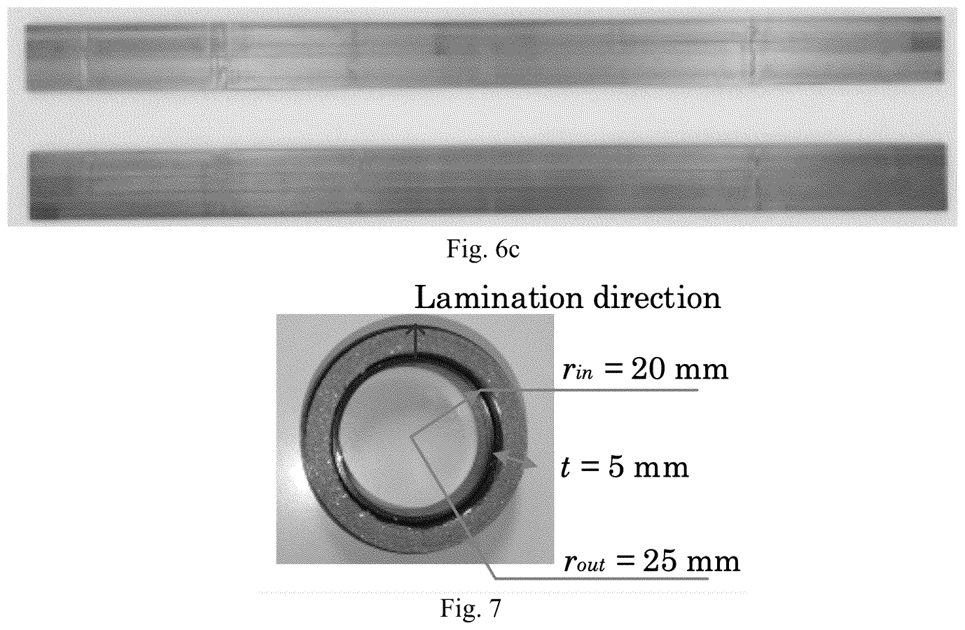

To evaluate the core loss Pᵥ of the nanocrystalline materials, core samples are made to perform the measurements. The horizontally laminated nanocrystalline ribbon core sample, as depicted in FIGS. 6a-6c, is manufactured by Proterial, Ltd. The core sample illustrated in FIG. 6a takes the form of a race track, creating a complete magnetic path and constraining the flux within the core. This allows for the application of the core loss measurement method before assembly on IPT pads. FIG. 6b shows the cutting of the race track core, resulting in the formation of the I-type core utilized in IPT, as shown in FIG. 6c. The dimensions of the I-type core are 460 mm×25 mm×5 mm.

FIG. 7 shows the dimensions of the vertically laminated NFR core, with a ring core shape of 5 mm thickness. The cross-sectional area is 100 mm², the magnetic length being 141.37 mm, and the core volume is 14137 mm³. The lamination direction points from the inner to the outer radius. Since the permeability of the NFR can be configured with different crushing setups, three samples with NFR1, NFR2, and NFR3 are measured. The property comparisons with Finemet® cores are shown in Table II. The permeabilities are calculated with inductance values while the conductivity is measured on the surface with the four-probe method following IEC60404.

TABLE II
PROPERTIES MEASUREMENTS OF THE
SELECTED LAMINATED MATERIALS

| Propertie | Finemet ® | NFR1 | NFR2 | NFR3 |
|---|---|---|---|---|
| □ᵣ | 17710 | 1477 | 4027 | 8338 |
| □_{c} | 13813 | 1256 | 3423 | 7088 |
| □ₗ | 4.35 | 6.64 | 6.66 | 6.66 |
| □_{c}(S/m) | 571429 | 3.5 | 55 | 202 |

Note:
the permeabilities are re-calculated based on the inductance value.

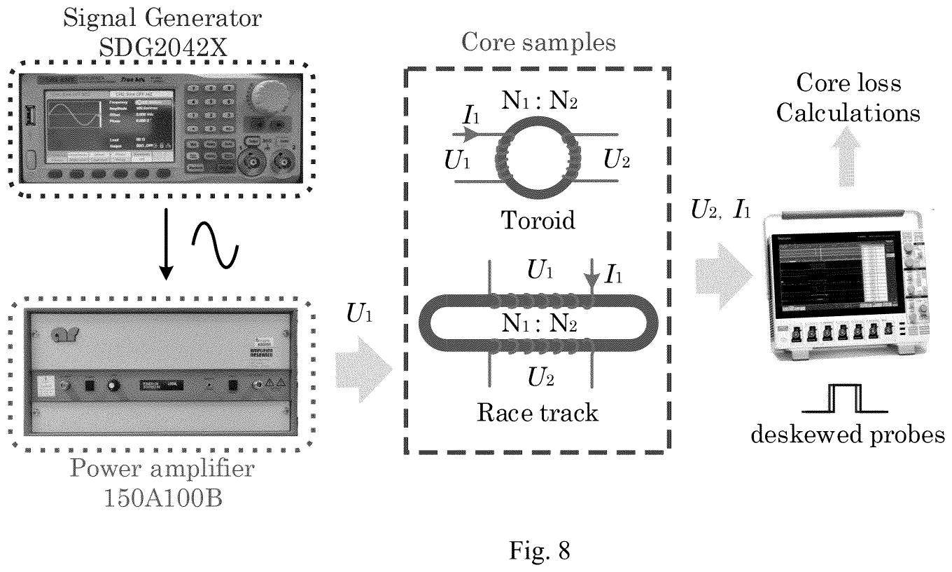

The core loss measurement setup is shown in FIG. 8. The signal generator SIGLENT SDG2042X generates a sinusoidal signal, which is further applied by the power amplifier AR 150A100B. The core under test employs the conventional two-winding configuration. The oscilloscope Tektronix MSO46 with differential voltage probes THDP0200 and current probes TCP0030A is employed to capture the primary current I₁ and secondary voltage U₂. The measurement device has been deskewed to minimize the phase discrepancy. The magnetic field intensity H and flux density B can be calculated as (9).

$$\{ \begin{matrix}H ( t ) & = \frac{{N}_{1} {i}_{1} ( t )}{{l}_{c}} \\ B ( t ) & = \frac{1}{{A}_{c} {N}_{2}} {\int }_{{t}_{0}}^{{t}_{0} + T} {u}_{2} ( t ) dt\end{matrix} \qquad ( 9 )$$

where N₁ and N₂ are the winding numbers of the primary and secondary sides of the cores under test. The magnetic length l_{c} and cross-sectional area A_{c} are calculated based on the core geometry. T is the period of the excitation. Based on the loss definition with magnetic field intensity and flux density in (10), the core loss Pᵥ can be calculated accordingly.

$${P}_{v} = \frac{{A}_{c} {l}_{c}}{T} {\int }_{{t}_{0}}^{{t}_{0} + T} HdB \qquad ( 10 )$$

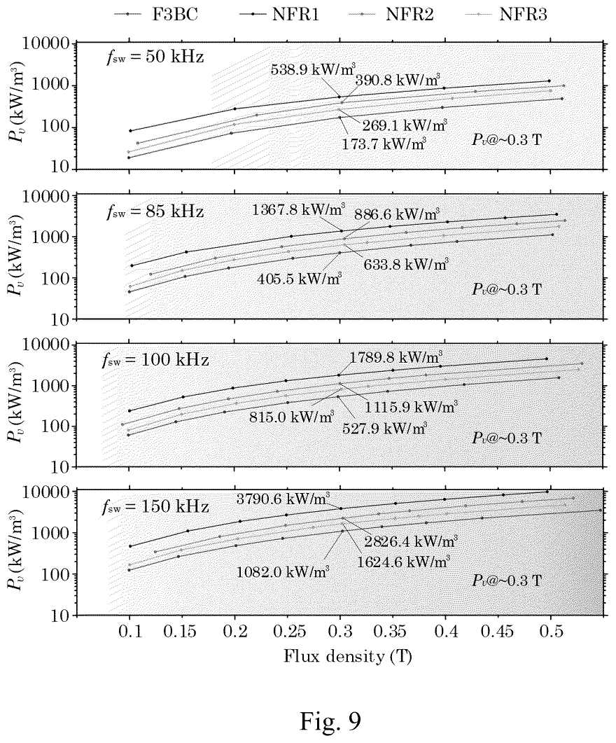

The calculated loss does not account for winding loss as it utilizes the open secondary voltage. FIG. 9 shows the direct core loss measurements in the sheet direction. The measurements are up to around 0.5 T and with 50 kHz, 85 kHz, 100 kHz, and 150 kHz. Higher flux density will lead to serious current waveform distortion due to the magnetic cores starting to saturate and the inductance dropping significantly.

Among the materials evaluated, the Finemet® core exhibits the lowest core loss under identical flux density conditions across all tested frequencies. For NFR materials, there is a noticeable increase in core loss as their permeability decreases in the core loss measurement of toroidal core. For instance, at an excitation frequency of 85 kHz and a flux density of 0.3 T, the measured core losses for NFR1, NFR2, and NFR3 materials are 1367.8 kW/m³, 886.6 kW/m³, and 633.8 kW/m³, respectively. These figures are significantly higher than those for the Finemet® core, which is 405.5 kW/m³, even though the Finemet® has smaller stacking factors.

This reveals that for toroidal cores where the majority of the flux aligns with the sheet direction, the crushing process of the NFR material cannot improve the loss performance. Nevertheless, the additional eddy current loss Pₙ, which is highly geometry-dependent, can vary significantly in IPT applications. The results of the measurements, which represent the core loss model for Pᵥ, are utilized in the FEM simulation which will now be described.

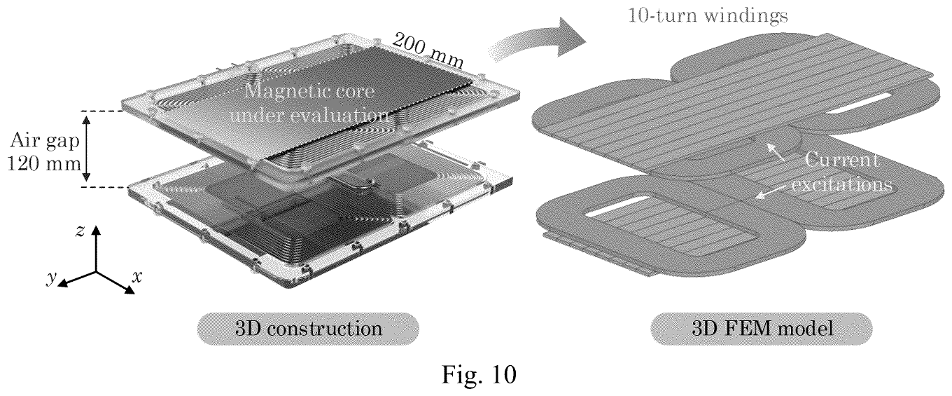

The evaluation and optimization of the magnetic core is performed with FEM simulation. FIG. 10 shows the 3D mechanical construction and the equivalent FEM model. The system is designed with double-D windings.

The air gap between the primary and secondary pads is 120 mm. To pursue higher power density, the target core thickness is set to 4 mm, while the magnetic core area covers only an area of 200 mm×460 mm. The primary and secondary windings are symmetric, with 10 turns on each winding. A series-series compensation network for the coupler is assumed. 15-A current excitations are assigned for the primary and secondary sides. The anisotropic material characteristics of the horizontally and vertically laminated core are modelled with (4) and (5), with the former one laminated along the x direction, and the latter laminated along the z direction.

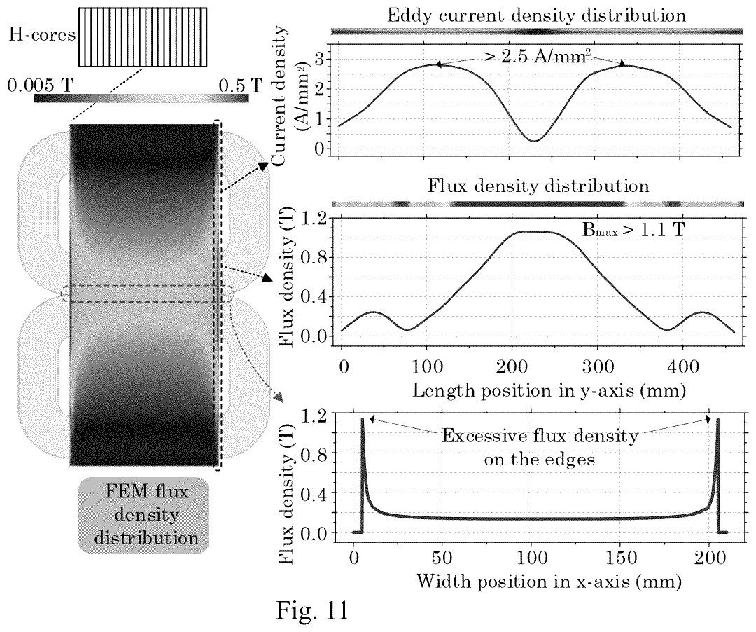

The FEM simulations with horizontally laminated NRC cores are performed first. FIG. 11 shows the flux density distribution results. The edge loss problem can be revealed from the results. Due to the lamination direction being parallel with the winding plane, the permeability towards the inner side of the core is extremely low, which is only several times higher than air. This eventually results in the concentration of the flux on the edge. The outer layers shielded the inner from the magnetic field. The eddy current reaches over 2.5 A/mm² on the edge close to the window area. This high eddy current is because of the high conductivity of the layers. This high eddy current also generates the magnetic field, creating magnetic flux which will superimpose the flux from the excitation current sources. The superimposed flux density inside the core B_{core} is therefore

$${B}_{core} = {B}_{j} + {B}_{eddy} \qquad ( 11 )$$

where Bᵢ and B_{eddy} are the resulting flux densities from the excitations and induced eddy current respectively.

The superimposed flux density of the NRC cores reaches over 1.1 T on the center edge, close to the saturation flux density. Excessive loss will be generated on the edge, despite a relatively low overall core loss. The hot spot can create severe thermal issues. Even though the nanocrystalline material has a high Curie temperature over 600° C., the high temperature of the core material can potentially melt the adhesive layers and the insulations. In addition, the inner cores are conducting few flux densities despite the high permeability, resulting in low utilization of the core material.

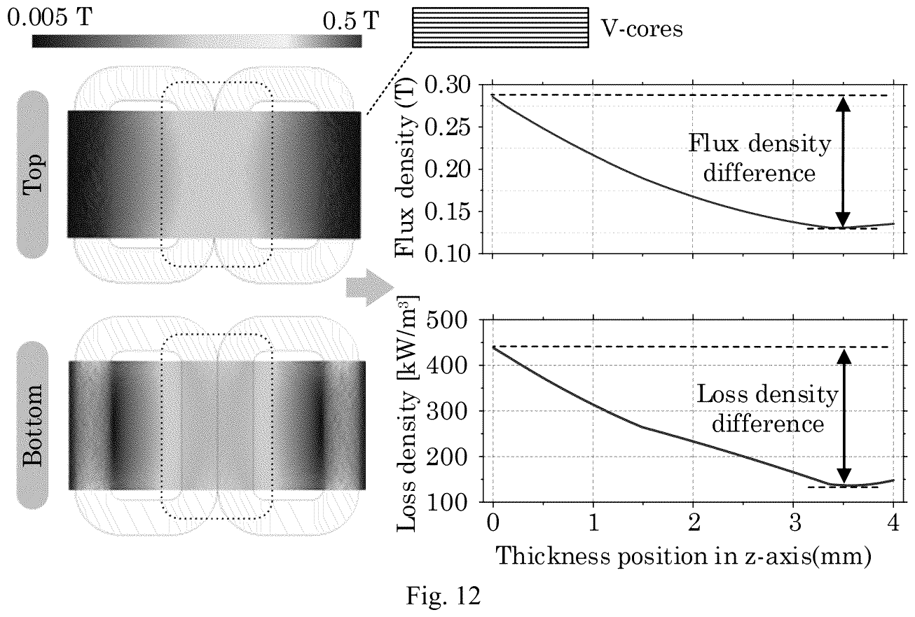

The problem of vertical lamination is different. Simulation with vertically laminated NFR3 material is shown in FIG. 12. The elimination of the edge problem is observed due to the equal permeability in the x-y plane. However, an uneven distribution of flux along the z-axis becomes evident. The flux density decreases as the position moves away from the windings. This eventually leads to a concentration of the loss on the inner layers, with the highest core loss peaking at 450 kW/m³ while the lowest is less than 150 kW/m³ even in the same x-y coordinates.

Saturation does not occur in the vertically laminated NFR cores, allowing for the proper operation of the magnetic coupler. However, when taking into account the norm flux density, the presence of additional induced eddy current loss Pₙ results in an increase in the overall core loss. As a consequence, the efficiency of the magnetic coupler is reduced.

For the cross-lamination structures shown in FIGS. 2a-2e, the H-cores may consist of Finemet® cores, which exhibit excellent core loss characteristics, as demonstrated in the core loss measurements. The V-cores, which may be made of NFR materials, redirect the magnetic flux (Bₙ) for the H-cores. The main purpose of V-cores is to prevent excessive loss at the edges and enhance the utilization of the core material.

FIGS. 13a-13c depict the flux distribution of the first variation of the cross-laminated cores, comprising Finemet® cores as the horizontal lamination and three different NFR cores as the vertical lamination. The cross-lamination consists of five horizontal laminated cores, each with a width of 25 mm, and six vertically laminated cores, each with a width of 12.5 mm. The widths are chosen to have an equal core area as the single-lamination cores for a fair comparison. Notably, the cross-lamination effectively balances the distribution of flux along the thickness direction. Additionally, as the permeability of the NFR material increases, the peak flux density (Bₘₐₓ) can be reduced. In comparison, the cross-lamination with Finemet® and NFR3 exhibits the lowest peak flux density, reducing it from 1.1 T to 0.46 T. This substantial reduction in flux density contributes to a more uniform distribution of both flux density and temperature.

FIG. 13d and FIG. 13e use the demonstration design with the magnetic cores covering the whole winding plane. FIG. 13d illustrates the flux distribution of the H-cores and the FIG. 13e is for the second variation of the cross-laminated cores, comprising Finemet® cores as the horizontal lamination and NFR3 core as the vertical lamination. The thicknesses of Finemet® and NFR3 are 4 mm and 0.25 mm respectively. In this setup the magnetic core covers the entire winding area, and the problem of flux concentration on the edge persists, with the peak flux density reaching 0.58 T. By addition of the NFR3 with vertical lamination as the flux balancer, the flux concentration on the edge is completely eliminated, with the peak flux density only in the middle at around 0.16 T. This configuration reduces the total core loss by 30%.

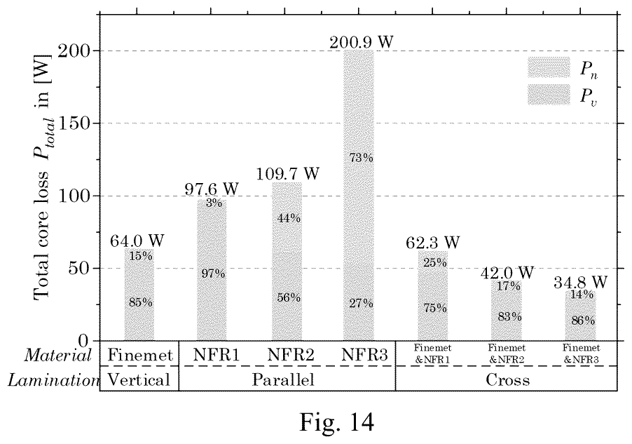

FIG. 14 compares the core losses of different configurations. The core loss derived from toroidal measurements, Pᵥ, and the core loss attributed to eddy currents due to normal flux, Pₙ, are separated. Since the simulations maintain a constant frequency of 85 kHz, Pᵥ is influenced solely by the flux density. In contrast, Pₙ is influenced by both the geometry and the conductivity of the material. For horizontal lamination with Finemet® cores, the sheet orientation aligns with the main flux direction, resulting in Pₙ accounting for only 15% of the total core loss, despite having the highest conductivity. Conversely, vertical lamination leads to increased eddy current losses due to its geometry. Given that Pₙ increases proportionally with conductivity as indicated in (6), the total loss for NFR3 is higher than that for NFR2 and NFR1, peaking at 200.9 W. Thus, more crushing of NFR material results in a lower core loss in IPT applications, which contrasts with the findings from toroidal core measurements. In comparison, the cross-lamination structure demonstrates a comprehensive improvement, particularly when Finemet® cores are combined with higher permeability NFR3 materials. This can be attributed to two aspects. Firstly, the flux distribution within the Finemet® is more uniform. The core loss Pᵥ drops thereafter. Secondly, the eddy current loss in NFR material is significantly reduced due to the incorporation of higher permeability Finemet® material. The combination of horizontal and vertical laminations lowers the overall Bₙ by effectively redirecting the flux, as evidenced by the reduced eddy current loss, Pₙ. The simulations of cross-lamination suggest a feasible approach for employing laminated cores in IPT applications.

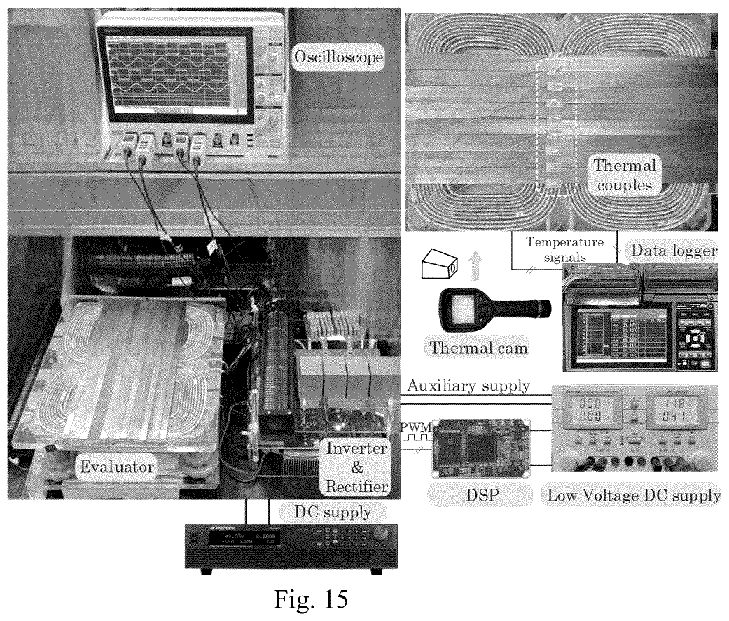

The performance of the cross-lamination structure is further verified experimentally. FIG. 15 shows the experiment platform. The magnetic core evaluator, consisting of primary and secondary pads, is connected to a full bridge inverter and rectifier. The output from the rectifier is directly connected to the input of the inverter, which is powered by a DC source. Essentially, the output current recirculates back to the input for high-power tests. Therefore, the overall system only draws external power to cover losses, allowing for a straightforward efficiency calculation based on the output current, input voltage, and losses in the DC supply. Control of the inverter is done by a DSP TMS320F28377D. The temperature signals are captured using K-type thermocouples and recorded with the data logger LR8450. Additionally, the thermal camera FUR E6-XT is employed to monitor the temperature distribution.

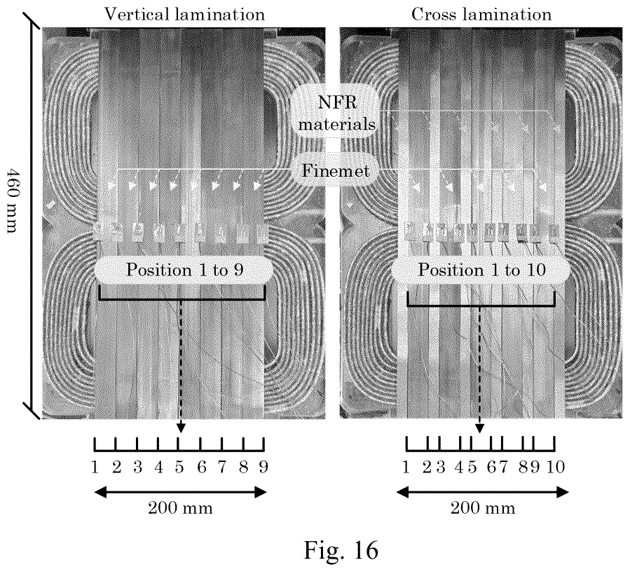

FIG. 16 shows the detailed structure of the magnetic cores with horizontal and cross laminations, as well as the thermal couple positions. The dimensions of the magnetic cores under tests are the same as in the simulations, with 460 mm length and 200 mm width. Simulations indicate that the highest flux densities typically appear at the edges of each Finemet® core. Therefore, the thermocouples are placed at the edges of each core bar, aligned with the central area of the double-D windings. The diagram specifies locations 1 to 9 for horizontal laminations and 1 to 10 for cross laminations.

To facilitate a direct and fair comparison, the primary side employs Finemet® core material, whereas variations are made only to the secondary side. The inductance measurements are conducted using an LCR meter set to an excitation frequency of 85 kHz and an amplitude of 0.5 Vrms. Results regarding self and mutual inductance values are presented in Table II. Here, L₁ and L₂ represent the self-inductances of the primary and secondary pads, respectively, M denotes the mutual inductance, and k is the coupling coefficient. Notably, the cross-lamination structure exhibits increased self-inductance but reduced mutual inductance. This behavior is attributed to the flux linkage primarily traversing the window area of the double-D windings in the z-axis direction. This finding is consistent with the anisotropic modeling of the material, which indicates that NFR cores exhibit significantly lower permeability in the z-axis due to their vertical lamination structure, resulting in decreased coupling in the cross-lamination structure.

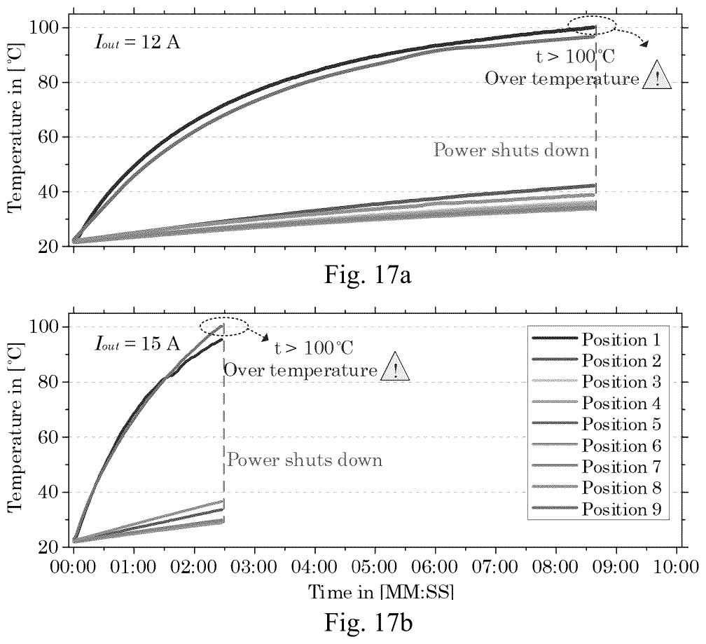

The tests are performed first with horizontal laminations. FIG. 16 shows the recorded temperature from position 1 to 9 in a time scope of 10 minutes. FIG. 17a and FIG. 17b operate in 12 A and 15 A output currents, respectively. The ambient temperature is 23° C. The evaluator is in natural convection conditions without any active cooling measures. The over-temperature shutdown threshold is set at 100° C. to ensure the adhesives within the cores and the insulation of the contacted Litz wires are not damaged. It can be observed from the results that the temperatures of positions 1 and 9, which are the edge positions, rise significantly faster than other positions. Particularly at a current of 15 A, the edge temperatures exceed 100° C. within just 2 minutes and 30 seconds, activating the over-temperature shutdown and subsequently interrupting the power transfer. The variation between the highest and lowest recorded temperatures across the positions exceeds 70° C., creating significant thermal stress in the edge cores, which could adversely affect the product life of the devices.

Lowering the output current can mitigate the temperature disparity, as demonstrated in FIG. 17a with a 12 A output. However, the temperatures at positions 1 and 9 still reached the threshold after 8 minutes. Given the current arrangement of the cores, a single horizontal lamination configuration is unsuitable for high-power output.

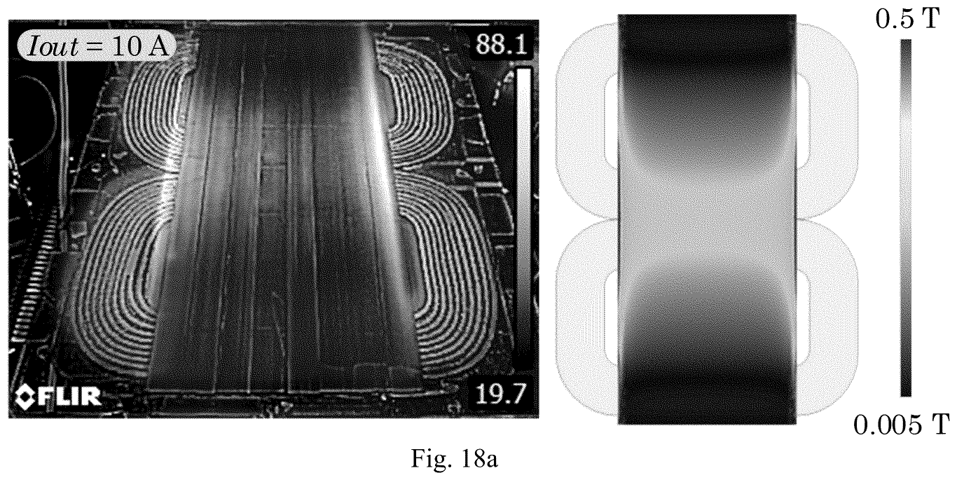

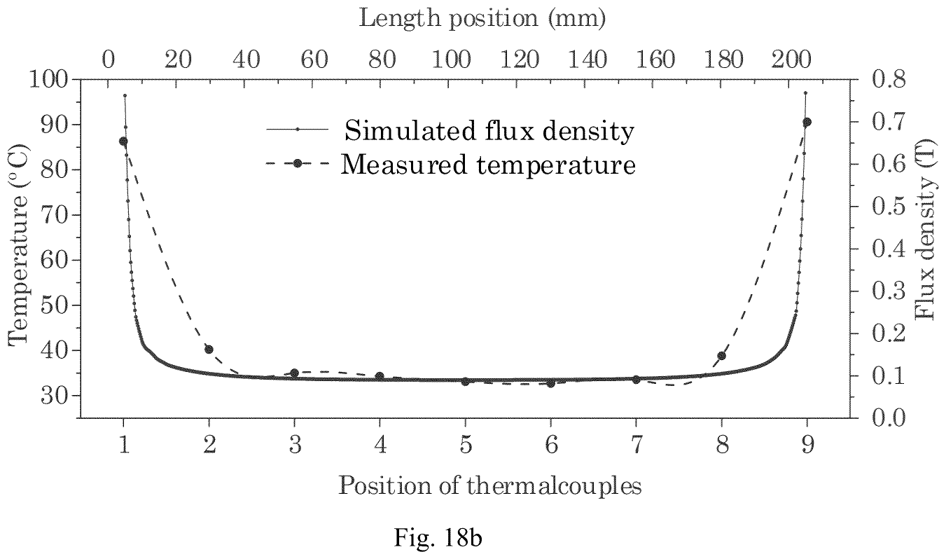

FIGS. 18a and 18b present a comparison between the temperature distribution observed in thermal images and the simulated flux density distributions. The results are conducted under a test condition of 10 A, where the temperature stabilizes below the over-temperature threshold after 30 minutes of operation. The consistency between the temperature and flux density distributions is evident that the highest temperatures are recorded along the edges, highlighting a significant difference between the temperatures at the inner and outer areas. FIG. 18b further illustrates the temperature values alongside the simulated flux density and further supports the validity of the anisotropic simulation model. A slight asymmetry in the temperature recording is observed, potentially due to positional tolerances and air gaps between the cores.

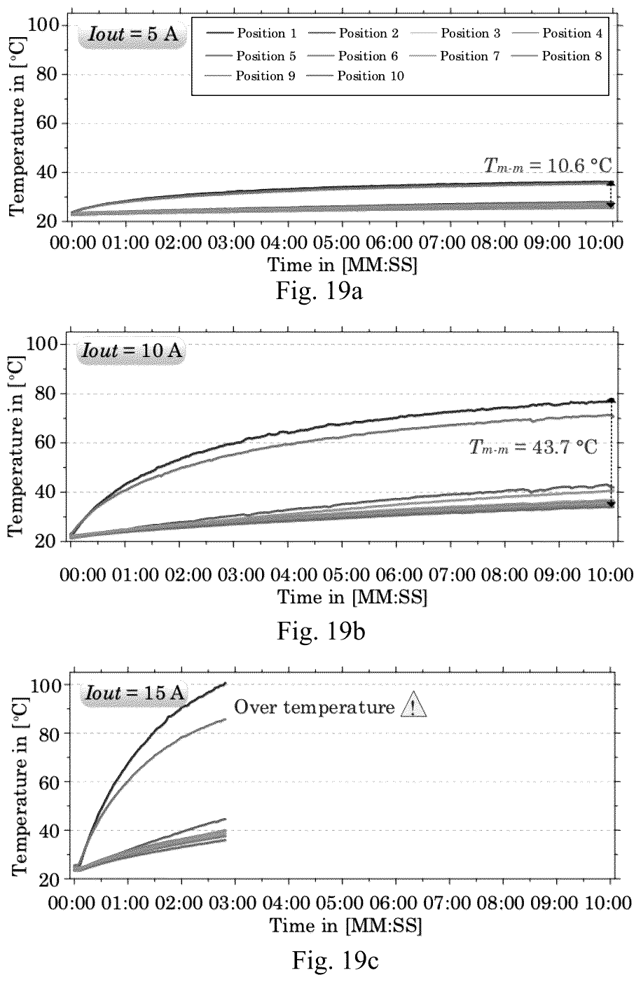

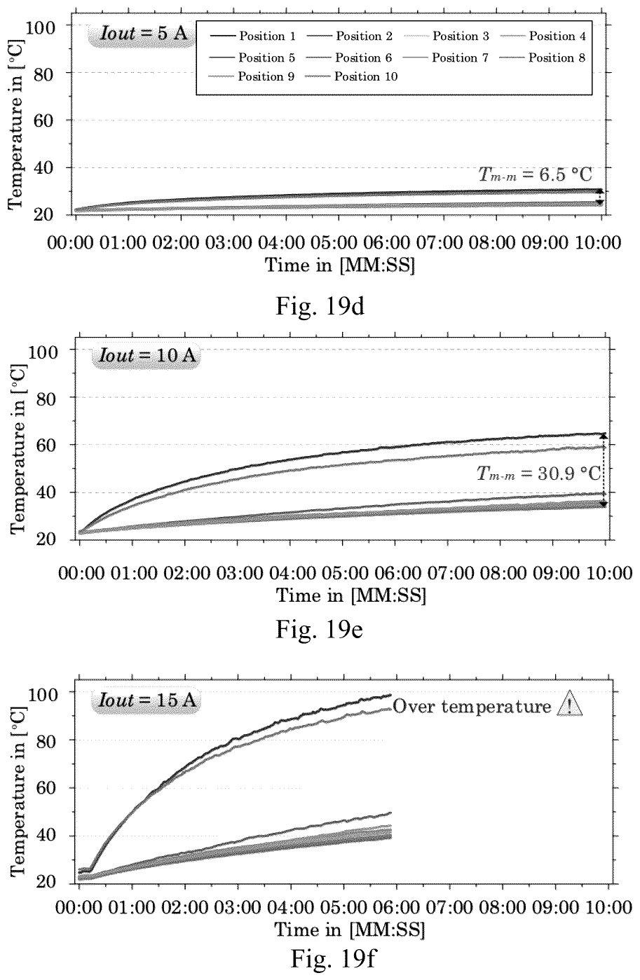

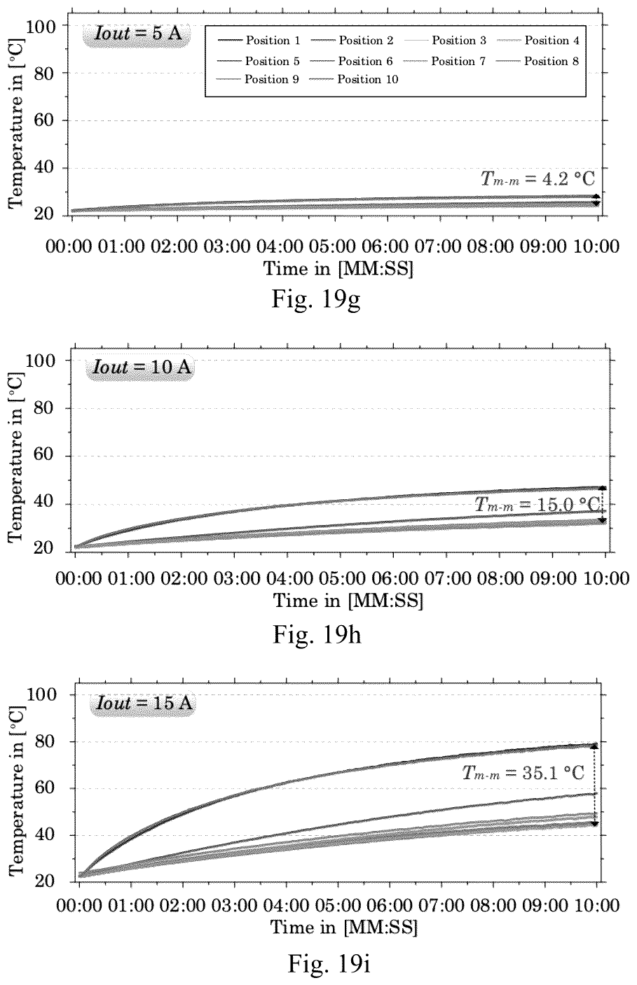

FIGS. 19a-19i display the temperature measurements for various cross-laminated configurations under output currents of 5 A, 10 A, and 15 A. The configurations tested include Finemet® & NFR1, Finemet® & NFR2, and Finemet® & NFR3. Similar to temperature measurements taken on Finemet® cores, the highest temperatures occur at Positions 1 and 10, indicating significant edge loss. The lowest temperatures are observed at Positions 5 and 6, located at the central positions. The temperature range between the highest and lowest recorded temperatures is denoted as Tₘ₋ₘ.

Consistent with flux density distributions, the cross-lamination structure enhances both the temperature distribution and the peak temperature. Notably, as the permeability of the NFR material increases, these improvements become more evident. In terms of operational duration, Finemet® & NFR1 and Finemet® & NFR2 configurations extend to 2 minutes 40 seconds and 5 minutes 50 seconds, respectively, compared to single horizontally laminated Finemet® cores. The Finemet® & NFR3 setup can operate continuously without triggering over-temperature protections.

The temperature difference, Tₘ₋ₘ, is reduced from 10.6° C. to 4.2° C. at a 5 A output, and from 43.7° C. to 15° C. at a 10 A output with the Finemet® & NFR. These enhancements not only increase the operation times but also reduce thermal stress on the magnetic cores, thereby reducing the need for cooling efforts.

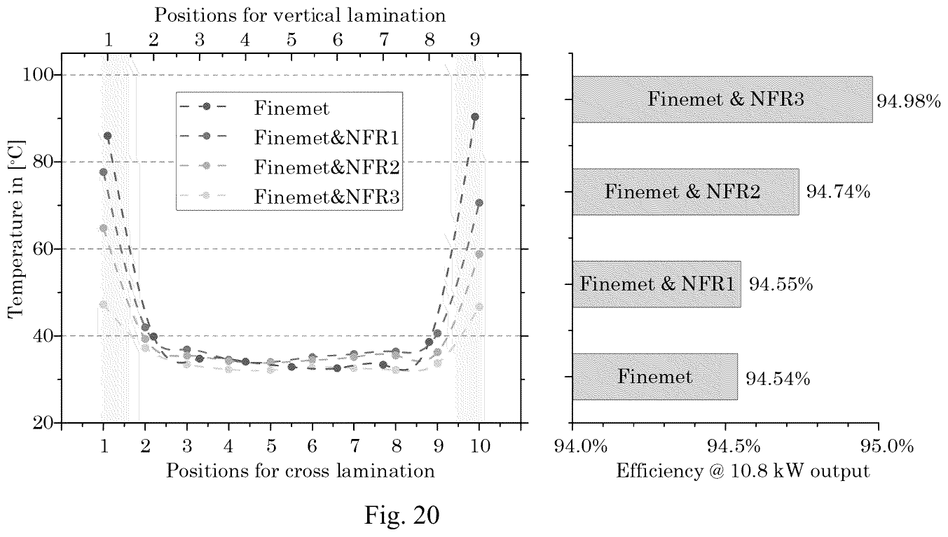

FIG. 20 summarizes the final measured values for the four configurations at a 10 A output. The cross-laminated structure, particularly the Finemet® & NFR3 configuration, demonstrates a notable improvement above 40° C. The core's inner areas maintain very similar temperatures. The efficiencies of the four configurations are 94.54%, 94.55%, 94.74%, and 94.98% at an output power of 10.8 kW, indicating an efficiency increase of over 0.4% for Finemet® & NFR3 compared with single horizontal laminated Finemet®. However, at this power level, active cooling is essential to maintain temperature increases within safe limits for long-duration operation. In summary, the cross-lamination structure demonstrates a higher efficiency compared with single vertical lamination, as well as a significant reduction on the maximum temperature, particularly with Core3 material.

The innovative cross-lamination structure also simplifies the construction by reducing the number of horizontal laminations required. Typically, H-cores necessitate the assembly of thousands of thin magnetic and adhesive layers to achieve a core width of 25 mm, significantly increasing manufacturing costs. In contrast, vertical laminations involve fewer than 200 layers due to the core bar's thickness, which generally ranges from 3 to 5 mm in the WPT3 wireless charging system, thereby reducing production expenses.

The experimental results with cross-lamination indicate that configuring V-cores with higher permeability materials is more effective. The improvement with Finemet® & NFR3 is more evident than the other two. The reason is that the permeability of NFR1 material is only about 10% of that of horizontally laminated Finemet®. The reluctance of the material is much higher, resulting in a limited ability to redirect flux. The maximum relative permeability of the selected NFR materials reaches up to 7000. However, the impact of even higher permeability in vertical laminations is yet to be determined, as it is anticipated that conductivity might significantly increase due to reduced crushing. Consequently, the increase in norm flux eddy current losses Pₙ might outweigh the benefits.

In summary, the analysis above begins with anisotropic modelling of the laminated cores, followed by toroidal measurements using a power amplifier to determine core losses when flux aligns with the lamination sheet direction. By distinguishing losses from toroidal measurements and eddy current losses due to normal flux, finite element models are developed. The following simulations reveal that horizontal laminations exhibit a significant imbalance in flux distribution, whereas vertical laminations incur substantial additional eddy current losses. By alternating horizontal and vertical laminations, the flux distribution imbalance along the thickness direction can be evened out, and peak flux density at the edges can be reduced. Subsequent experimental results validate these simulations. Using single horizontal laminations, thermal camera observations of temperature distribution coincide with the simulated flux density distribution. The maximum temperature rapidly reaches the over-temperature limit at an output current of 15 A. In contrast, the cross-lamination structure enhances performance, reducing the maximum temperature by over 40° C. and increasing efficiency by over 0.4% at an output power of 10.8 kW. The proposed cross-lamination structure provides a viable approach to implement laminated cores in high-power IPT applications for EVs, enhancing saturation capacity and thermal stability with higher power density. The novel structure alleviates the inhomogeneous distribution of the flux density and core loss.

One can see that preferred embodiments of the invention provide a cross-lamination structure for laminated cores in double-D winding inductive power transfer applications. The cross-lamination structure cores can be used in the construction of inductive coils used in wireless charging systems. These cores are structured from multiple thin layers of metal, typically electrical steel, separated by insulating material. The combination of vertical and parallel laminations enhances the efficiency as well as thermal uniformity. The function of the structure includes firstly, the cross-laminated cores significantly reduce eddy currents. These are loops of electrical currents induced within conductors by changing magnetic fields, which if unchecked, can cause substantial power losses and generate excessive heat. By minimizing these currents, the cores ensure more efficient transfer of magnetic flux, which is critical for the energy transfer in wireless charging. Secondly, the design of cross-laminated cores helps maintain high magnetic permeability. This property is crucial for achieving strong magnetic coupling between the transmitter and receiver coils—the primary pathway through which energy is transferred wirelessly. High permeability allows for the generation of a strong magnetic field with less energy, thereby boosting the system's overall efficiency. Moreover, the cross-laminated cores help to increase the power density. Due to the fact that most of the lamination materials exhibit high saturation flux density, the cores can be designed very thin, reducing the overall thickness of the wireless charging pad.

The cross-laminated cores offer several advantages over solid ferrite cores in wireless charging systems, particularly due to their structural and material characteristics.
1. Eddy Current Reduction: Laminated cores are composed of multiple thin layers of electrical steel, each insulated from the others, which significantly reduces the formation of eddy currents. These currents, induced by changing magnetic fields, lead to power loss and heat generation. The laminated structure minimizes these losses far more effectively than the solid structure of ferrite cores, despite ferrite's high electrical resistivity.
2. Magnetic Permeability and Efficiency: The cross-laminated cores maintain high magnetic permeability, crucial for effective magnetic coupling and efficient power transfer.

They can handle higher flux density with lower losses compared to ferrite cores, which have lower saturation magnetization, limiting their effectiveness in high-power applications.
3. Heat Dissipation: The layered structure of the cross-laminated cores facilitates better heat dissipation, reducing the risk of overheating and enhancing system durability. Ferrite cores, being solid, struggle with heat management under similar conditions.
4. Versatility and Customization: The cross-laminated cores can be easily customized in terms of shape and size, providing flexibility in design to optimize specific applications. Ferrite, being brittle, offers less precision and customization capabilities.
5. Cost and Practicality: Although the cross-laminated cores might initially be more expensive due to their complex manufacturing process, their superior performance and efficiency in demanding, high-power environments often justify the cost. Ferrite cores are cheaper and suitable for lower-power applications.

These benefits make laminated cores particularly suitable for high-performance wireless charging applications where efficiency, heat management, and power handling are paramount.

In practical applications, wireless charging utilizing cross-laminated cores is employed in various sectors. It is prominently used in consumer electronics, such as smartphones and laptops, to provide a convenient, cable-free charging solution. Additionally, it's increasingly being adopted in automotive industries for charging electric vehicles and in healthcare for powering medical devices. The use of the cross-laminated core structures in these applications not only increases the efficiency of charging but also extends the longevity and reliability of the devices being charged.

Moreover, a novel application of wireless charging technology is emerging in the maritime sector, specifically for charging electric ships. This development aims to reduce dependency on traditional fossil fuels and enhance the sustainability of maritime transport. Wireless charging for ships involves creating a charging station, either at the dock or embedded in the port's infrastructure, where ships equipped with compatible wireless charging receivers can charge without the need to physically plug in. This system can significantly streamline the process of recharging electric vessels, making operations more efficient and less labor-intensive. The adoption of cross-laminated cores in such systems could further optimize the efficiency and reliability of wireless charging in harsh marine environments, ensuring strong magnetic coupling despite the challenging conditions. This expansion into marine applications not only broadens the market for wireless charging solutions but also contributes to the green transformation of the shipping industry.

The exemplary embodiments are thus fully described. Although the description referred to particular embodiments, it will be clear to one skilled in the art that the invention may be practiced with variation of these specific details. Hence this invention should not be construed as limited to the embodiments set forth herein.

While the embodiments have been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

What is claimed is:

1. A magnetic flux device configured to transmit or receive magnetic flux to or from a space beyond the magnetic flux device, the magnetic flux device comprising:
a) a first electrically conductive coil; and
b) a magnetically permeable core comprising:
i) a plurality of first laminated cores each laminated along a first direction; and
ii) a plurality of second laminated cores each laminated along a second direction substantially perpendicular to the first direction;

2. The magnetic flux device of claim 1, further comprises a second electrically conductive coil which is configured side-by-side with the first electrically conductive coil to form a double-D winding structure.

3. The magnetic flux device of claim 1, wherein both the first direction and the second direction are parallel to a virtual plane in which the first electrically conductive coil is located.

4. The magnetic flux device of claim 2, wherein the second direction is parallel to a virtual line that connects a centre of the first electrically conductive coil and a centre of the second electrically conductive coil; the second direction and the first direction being parallel to a virtual plane in which the first electrically conductive coil and the second electrically conductive coil are located.

5. The magnetic flux device of claim 1, wherein each said first laminated core comprises a plurality of first laminations, and each said second laminated core comprises a plurality of second laminations; the first laminations and the second laminations being co-planar.

6. The magnetic flux device of claim 1, wherein the plurality of the first laminated cores is placed on one side of the plurality of the second laminated cores, as a magnetic flux balancer, to reduce flux concentration.

7. The magnetic flux device of claim 5, wherein the plurality of the first laminations comprises a plurality of insulation layers and a plurality of first soft magnetic core (SMC) layers that are interlaced.

8. The magnetic flux device of claim 7, wherein both the plurality of insulation layers and the plurality of first SMC layers extend along the first direction.

9. The magnetic flux device of claim 7, wherein the plurality of second laminations comprises a plurality of insulation layers and a plurality of second SMC layers that are interlaced.

10. The magnetic flux device of claim 9, wherein both the plurality of insulation layers and the plurality of second SMC layers extend along the second direction.

11. The magnetic flux device of claim 9, wherein the plurality of first SMC layers has higher permeability in directions along a layer surface than the plurality of the second SMC layers.

12. The magnetic flux device of claim 9, wherein the plurality of first SMC layers has lower permeability in a direction perpendicular to a layer surface than the plurality of the second SMC layers.

13. The magnetic flux device of claim 9, wherein the plurality of first SMC layers has higher conductivity than the plurality of the second SMC layers.

14. The magnetic flux device of claim 11, wherein the plurality of first SMC layers is made of a Fe-based nanocrystalline material; the plurality of second SMC layers made of a nanocrystalline flake ribbons (NFR) material.

15. The magnetic flux device of claim 5, further comprises a base plate on which a plurality of core clamps is configured; the core clamps securing the plurality of first laminations and/or the plurality of second laminations to the base plate.

16. The magnetic flux device of claim 1, further comprises an insulation film arranged between the first electrically conductive coil and the magnetically permeable core.
